(19) United States
(12) Patent Application Publication
(10) Pub. No.: US 2023/0412314 A1
(43) Pub. Date: Dec. 21, 2023

(54) METHODS AND ARRANGEMENTS FOR RETRANSMISSION SCHEMES

(71) Applicant: Intel Corporation, Santa Clara, CA (US)

(72) Inventors: Wei Mao, Pleasanton, CA (US); Minyoung Park, San Ramon, CA (US); Hosein Nikopour, San Jose, CA (US)

(73) Assignee: Intel Corporation, Santa Clara, CA (US)

(21) Appl. No.: 18/210,984

(22) Filed: Jun. 16, 2023

(51) Int. Cl. H04L 1/1812; H04L 5/00; H04L 1/00

(52) U.S. Cl. CPC H04L 1/1816; H04L 5/0055; H04L 1/0057

(57) ABSTRACT

Logic to determine a first set of packets for transmission to a second STA in an aggregated medium access control (MAC) protocol data unit (A-MPDU). Logic to identify a retransmission scheme to determine a first number of packets to transmit based on the first set of packets. Logic to generate network coded packets for transmission in the A-MPDU, wherein the network coded packets comprise encoded combinations of the first set of packets. Logic to generate the A-MPDU for transmission to the second STA with the first number of packets. Logic to cause transmission of the A-MPDU. And logic to receive a block acknowledgement (BlockAck) comprising a feedback value, wherein the feedback value is a number of additional network coded packets requested by the second STA to decode the first set of packets or a number of packets received by the second STA.

### TECHNICAL FIELD

This disclosure generally relates to methods and arrangements for wireless communications and, more particularly, to network coding retransmission schemes.

### BACKGROUND

Today's Wi-Fi system does not have an efficient way to deliver a packet with very high reliability with low latency. The physical layer (PHY) can use a low modulation and coding scheme (MCS) to lower the packet error rate (PER), however, due to interferences caused by transmissions between other access points (APs) and stations (STAs) in the same frequency band at the same time, packet losses are inevitable. Retransmissions after a packet is dropped can improve reliability, but to reach a high reliability multiple retransmissions are necessary, and the latency may increase significantly. Another way to improve reliability is duplication, where the packet is repeated in the transmission within same frame or transmission opportunity (TXOP). However, this method significantly lowers the spectral efficiency. If PER is 0.1 and target reliability is 10⁶, then six duplicated packets need to be transmitted, lowering the effective data rate by 6×.

### BRIEF DESCRIPTION OF THE DRAWINGS

FIG. 1A depicts a system diagram illustrating an embodiment of a network environment for retransmission logic circuitry, in accordance with one or more example embodiments.

FIG. 1B depicts an embodiment illustrating interactions between stations (STAs) of a collated access point (AP) multi-link device (MLD) and a non-collocated AP MLD.

FIG. 1C depicts an embodiment of a system including multiple MLDs.

FIGS. 1D-1G illustrate embodiments of an architecture for STAs, such as the wireless interfaces for STAs depicted in FIGS. 1A-C, to implement retransmission logic circuitry.

FIG. 2A depicts an embodiment of network coding.

FIG. 2B depicts an embodiment of an aggregated MAC PDU (A-MPDU).

FIG. 2C depicts an embodiment of a packet flow for a retransmission scheme.

FIG. 2D depicts an embodiment of a network coding retransmission scheme.

FIG. 2E depicts an embodiment of a strategy for a retransmission scheme.

FIG. 2F depicts an embodiment of a two-step optimization approach.

FIG. 2G depicts another embodiment the two-step optimization approach.

FIG. 2H depicts another embodiment the two-step optimization approach.

FIG. 2I depicts an embodiment of a graph for a continuous case algorithm.

FIGS. 2J-2K depict embodiments of numerical results for the discrete case algorithm and a practical Wi-Fi configuration that requires the continuous case algorithm.

FIG. 3 depicts an embodiment of a wireless communications interface.

FIGS. 4A-4C depict embodiments of flowcharts to implement retransmission logic circuitry such as the retransmission logic circuitry discussed in conjunction with FIGS. 1-3.

FIGS. 4D-E depict embodiments of flowcharts to generate and transmit frames and receive and interpret frames for communications between wireless communication devices.

FIG. 5 depicts an embodiment of a functional diagram of a wireless communication device, in accordance with one or more example embodiments of the present disclosure.

FIG. 6 depicts an embodiment of a block diagram of a machine upon which any of one or more techniques may be performed, in accordance with one or more embodiments.

FIGS. 7-8 depict embodiments of a computer-readable storage medium and a computing platform to implement retransmission logic circuitry.

### DETAILED DESCRIPTION OF EMBODIMENTS

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Network coding, which may be a linear packet-level coding, in this case is a better-suited technology for low-latency and high-reliability data traffic. Network coding linearly combines data packets to form new encoded packets, which introduces dependence among them. By this reason, as long as a sufficient number of encoded packets (regardless of which ones) are correctly received at the receiver, the original data packets can be recovered despite the possible losses of all other encoded packets. Compared to current retransmission schemes, network coding proactively adds redundancy to the traffic and significantly reduces delay. Compared to packet duplication which is also a proactive scheme, network coding is much more spectrally efficient and not too much extra computational complexity is needed for encoding and decoding. Furthermore, network coding can also be combined with retransmissions to form a hybrid scheme, which has the benefits from both schemes. On the one hand, the proactively added redundancy in network coding at each (re)transmission can increase the chance of packet recovery at each transmission, thus reducing the number of retransmissions needed and the delay involved with packet recovery. On the other hand, the opportunities to get acknowledgement from the receiver and to retransmit only when needed can reduce unnecessary transmissions of redundant data and save radio resources.

We studied a practical configuration to implement the hybrid network coding scheme in Wi-Fi, utilizing the aggregated MAC PDU (A-MPDU) frame structure which aggregates multiple encoded packets as its subframes. In case these packets are not enough for recovering the original set of packets, a short BlockAck frame may be used to notify the sender and extra encoded packets can be sent in a subsequent A-MPDU frame. To implement such a hybrid scheme, many embodiments may perform a process to find the optimal number of encoded packets to send in each transmission and retransmission to minimize the radio resource consumption for successful data delivery, hence maximizing the spectral efficiency.

Embodiments herein may find retransmission scheme(s) using network coding under a time constraint, i.e., with a time limit for data transmissions. For example, due to the low latency requirement of some data traffic, a transmitter may not be able to afford the waiting time for channel access between transmission opportunities (TXOPs), and hence, some embodiments, impose a time constraint of completing any data transmission and retransmissions within one TXOP.

As we cannot have an infinite number of retransmissions within finite time, the data delivery may not be guaranteed to be successful. Instead, we may have a nonzero failure probability which we want to minimize if high reliability is also required for the data traffic. However, minimizing the data failure probability is not the sole objective for the optimization. If the level of reliability is already adequate for the data traffic, we still want to minimize the radio resource consumption, i.e., to maximize the spectral efficiency. For instance, if two schemes both achieve a required reliability, then the one with higher expected spectral efficiency (or smaller expected time usage) is preferred.

The two objectives are often in conflict though, since, in general, to reach higher reliability, more resources are required, which automatically lowers the spectral efficiency. In practice, different balance points between reliability and spectral efficiency (i.e., different rate-reliability trade-off) may be desired in different scenarios. For embodiments discussed herein, instead of directly optimizing toward the balance point of a given scenario, retransmission logic circuitry may find all the schemes that have the potential to be optimal for a certain scenario, given the time constraint. Specifically, retransmission logic circuitry may find the optimal rate-reliability “curve”, which is achieved by all schemes that do not underperform any other scheme in at least one performance measure. In doing so, the retransmission logic circuitry may find all the schemes that have the potential to be optimal for some scenario. For instance, if a first scheme is outperformed in all measures by another scheme, the first scheme cannot be optimal in any scenario. Mathematically, the curve is called the set of Pareto optimal points in terms of reliability and spectral efficiency, and the schemes may be referred to as Pareto optimal schemes. As the size of this set is usually significantly smaller than the set of all possible schemes, optimizing (over the Pareto optimal set) toward a particular balance point for a given scenario is usually much simpler.

Embodiments may comprise retransmission logic circuitry to determine or identify a retransmission scheme and implement retransmission scheme to improve the efficiency related to retransmission of dropped packets (erasure) when packets cannot be validated at the receiver. Many embodiments implement network coding to encode packets at the medium access control (MAC) layer with linearly independent encodings and, many embodiments encode linear combinations of a set of packets such that retransmission logic circuitry of the receiver need only receive the same number (e.g., k) of network coded packets that retransmission logic circuitry of a transmitter transmits to the receiver to decode the entire set of k original packets that the transmitter is attempting to transmit to the receiver.

Many embodiments may focus on retransmission schemes for A-MPDUs due to the low overhead associated with A-MPDUs but embodiments are not so limited. Many embodiments focus on retransmission schemes with a time-constraint (T) such as a time limit to a single transmission opportunity (TXOP) but embodiments are not limited to a time-constraint of a single TXOP.

Many embodiments implement Pareto optimal schemes by identifying a Pareto optimal retransmission scheme from a set of the Pareto optimal schemes based on the reliability and spectral efficiency specified for the retransmission scheme and based on the time-constraint (T) for the retransmission scheme. The retransmission schemes may have proactive and reactive retransmission strategies based on assumption of a packet loss being independent and identically distributed such as a packet loss rate (eᵣ) that remains within plus or minus 10%, plus or minus 20%, or plus or minus 30% of the assumed packet loss rate over a transmission and/or over multiple transmissions.

Many embodiments generate a full set of retransmission schemes, referred to as S(k′,T), and reduce the full set of retransmission schemes to a set of schemes, referred to as P(k′,T), that outperform other schemes in terms of reliability and/or spectral efficiency. For instance, many embodiments may determine an expected time usage for each scheme, a failure probability for each scheme, and a packet loss probability for each scheme. The expected time usage may be indicative of a spectral efficiency and the failure probability and packet loss probability may be indicative of a reliability.

Note that a retransmission scheme may comprise a strategy (g) and sub-strategies (g_{z,t}). The strategy may be illustrated as a tree where each point, or branch (e.g., B₀), along a tree within the strategy or within a sub-strategy represents a time (e.g., T₁) within the time-constraint (T) at which feedback may be received from retransmission logic circuitry of the receiver to select one of one or more possible sub-strategies. Each branch includes a set of possible sub-strategies for the branch. For instance, assume an original set of k packets provided for transmission from retransmission logic circuitry of a transmitter to retransmission logic circuitry of a receiver includes ten packets (k=2). The number of network coded packets n are generated based on the original set of k packets is ten (n=10). The number (x₁) of network coded packets sent in a first transmission to the receiver in a first transmission is three (x₁=3). Then the number of packets (e.g., Z₁) possibly received by a receiver may be between one and three. Thus, the strategy (g) may include a set of sub-strategies (e.g., z₁) defined for each possible number of packets received by the receiver such as between zero and three. In other words, the number of sub-strategies on the first branch may include four different sub-strategies. Note that the number of packets that can be transmitted (e.g., x₂) in a first retransmission in accordance with each sub-strategy is also limited to the time remaining (e.g., T₁) within the time constraint (T).

The strategy (g) may define the number (x₁) of network coded packets that are transmitted in the first transmission within the time-constraint (T). For instance, data provided to the MAC layer for transmission may be included in a set of MAC frames or packets called MAC service data units (MSDUs). Without implementation of a retransmission scheme described herein, the MAC layer may pass the set of packets to the physical layer (PHY) as an A-MPDU. The A-MPDU comprises a set of A-MPDU subframes. Each A-MPDU subframe may comprise one MAC protocol data unit (MPDU), which may be one MSDU. If there are 10 MDPUs, the PHY may transmit an A-MPDU with 10 A-MPDU subframes. Note that embodiments are not limited to one network coded packet per A-MPDU subframe. Some embodiments may include more than one network coded packet per A-MPDU.

For retransmission schemes described herein, however, the number (x₁) of network coded packets transmitted in the first transmission and, if applicable, in each of one or more subsequent retransmissions (x₁) may range between one packet and more than ten packets, depending on the retransmission scheme selected, the reliability that may be specified, the spectral efficiency that may be specified, the expected packet loss rate (eᵣ) (or error rate), the time constraint for retransmission (T), and/or other factors and boundaries discussed herein.

The sub-strategies for a strategy (g) may comprise the second and subsequent numbers of network coded packets transmitted to the receiver. The retransmission logic circuitry of the transmitter may determine number of packets to transmit for a sub-strategy based on the feedback value from the receiver as well as the time remaining for the subsequent transmissions. Identification of the number of packets to transmit and the time remaining for transmission for a sub-strategy identifies the sub-strategy. For instance, after the first network coded packet transmission, the time remaining within the time constraint for the retransmission scheme may be the total time of the time constraint (T) minus the sum of the transmission time (xᵢ*τ) and the sum (d) of the gap time and the feedback time consumed by the first (initial) network coded packet transmission. The feedback value (Zᵢ) may include a value that is the number of packets that the receiver actually received or decoded, or the number of packets that the receiver still needs to receive and/or decode to have the set of packets that the retransmission logic circuitry of the transmitter is attempting to transmit to the receiver. Each subsequent recursion (i) will reduce the amount of time remaining (Tᵢ) and may reduce the number of packets (k−Zᵢ) that the receiver still needs to receive from the receiver to have the entire original set of k packets. Note that, in many embodiments, each subset of k network coded packets are linearly independent, so the receiver only needs to receive the same number of network coded packets as the number of packets (k) in the set of packets that the retransmission logic circuitry of the transmitter is attempting to transmit to the receiver.

As a simple illustration, if the retransmission logic circuitry receives a set of four packets (k=4) to transmit to the receiver, the retransmission logic circuitry may determine that the retransmission scheme may have to transmit up to fourteen network coded packets to successfully transmit the set of four packets to the receiver. The retransmission logic circuitry may generate the fourteen network coded packets in a pool of network coded packets for transmission or may generate the fourteen network coded packets as the need arises (just prior to transmission) to perform a strategy or sub-strategy of the retransmission scheme. In many embodiments, the retransmission logic circuitry may systematically encode the original set of k packets to create the network coded packets in an order (e.g., network coded packets one through fourteen) and may cause transmission of the network coded packets in that order. Thus, the retransmission logic circuitry of the receiver may know the encoding for each network coded packet of the pool of network coded packets one through fourteen based on the order in which the network coded packets are received.

In some embodiments, the retransmission logic circuitry of the transmitter may cause transmission of x₁ network coded packets in the first transmission and provide an indication, e.g., in the header of the A-MPDU, that the total number of packets (k) in the set of packets is four (k=4), the retransmission logic circuitry of the receiver may comprise logic circuitry to decode the x₁ network coded packets. In some embodiments, the first four packets may be the original set of four packets and the fifth packet may be an encoded linear combination of the set of four packets. In other embodiments, the x₁ network coded packets may comprise x₁ linearly independent combinations of the set of four packets.

Continuing with the simple illustration, upon receipt of the x₁ network coded packets, the retransmission logic circuitry of the receiver may decode one packet without errors. As a result, the retransmission logic circuitry of the receiver may determine that one packet is received or decoded, and/or determine that the retransmission logic circuitry of the receiver requests to receive three more network coded packets to decode the set of four packets that the retransmission logic circuitry of the transmitter is attempting to transmit to the receiver. In this simple illustration, the retransmission logic circuitry of the receiver may generate a BlockAck that includes a feedback value of one to indicate that the receiver received or decoded one packet or that the receiver requests three packets to be able to decode all the packets of the original set of four packets. Note that the BlockAck does not have to include a bitmap indicating which packet(s) the receiver requests or needs. The feedback value may just indicate that three packets are requested or that one packet was received and/or decoded, which advantageously, can reduce the size and transmission time of BlockAck frame with respect to other BlockAck policies, reducing the overhead of generating and transmitting BlockAcks as feedback.

Upon receipt of the feedback value of one or three, the retransmission logic circuitry of the transmitter may generate an A-MPDU comprising (x₂), e.g., four, network coded packets in accordance with the retransmission scheme and pass the A-MPDU to the PHY for transmission to the receiver. If the retransmission logic circuitry of the receiver is able to decode at least three of the four network coded packets, the retransmission logic circuitry of the receiver has received all the packets from the original set of k packets that the retransmission logic circuitry of the transmitter was attempting to transmit. If sufficient time remains in accordance with the time constraint (T) for retransmission, the retransmission logic circuitry of the transmitter may generate the A-MPDU with an indication to request an immediate BlockAck and the retransmission logic circuitry of the receiver may respond to the A-MPDU with a BlockAck comprising a feedback value of four to indicate that the entire set of four packets of the original set of k packets (or three of the network coded packets) have been received. Alternatively, the BlockAck may comprise a feedback value of zero to indicate that zero more network coded packets are requested to indicate that the entire set of four packets are decoded or at least four of the network coded packets have been received. The retransmission logic circuitry of the transmitter may interpret the feedback value of three (or four or zero, depending on the type of feedback value) to indicate that the receiver has received all the packets of the original set of four packets and terminate the retransmission scheme for the original set of four packets.

In this example embodiment, considering that the maximum number of network coded packets that might be required for the pool of network coded packets is fourteen, the retransmission logic circuitry of the transmitter may generate ten network coded packets that are linear combinations of the set of four packets for the pool of network coded packets and may include or concatenate the set of four packets to the pool of network coded packets. In other embodiments, the retransmission logic circuitry of the transmitter may generate fourteen network coded packets that are linear combinations of the set of four packets to generate the pool of network coded packets for the retransmission scheme. In yet other embodiments, the retransmission logic circuitry of the transmitter may encode the set of four packets to include in the pool of network coded packets along with additional network coded packets that are linear combinations of the set of four packets.

The expected time usage, σ_{k,T}(g), for each retransmission scheme may be based on the number of network coded packets transmitted first to the receiver (x₁) as well as the number of network coded packets transmitted to the receiver in each possible set of subsequent transmissions (x₂ through xₙ) based on the possible combinations of sub-strategies. The expected time usage may also be based on the assumption that the network coded packets are all the same size, an assumption of a transmission time for each of the network coded packets (τ), and an assumption of a sum (d) of the gap time and the feedback time for feedback, which may include, e.g., the time for transitioning between receive mode and transmit mode for the receiver and/or the time for transitioning between transmit mode and receive mode for the transmitter, the time for transmitting the feedback, and the time for transitioning the transmitter and receiver back to the transmit and receive modes, respectively.

The decoding failure probability, η_{k,T}(g), for the first retransmission of each retransmission scheme may be the sum of the probabilities for each of the sub-strategies for the first retransmission that the actual number of packets remaining to transmit to the retransmission logic circuitry of the receiver (Z₁) at the first sub-strategy, is equal to the number of packets to transmit (z) by each of the possible first sub-strategies for the first retransmission multiplied by the failure probability of each possible first sub-strategy (g_{k,z}) from one (z=1) to the number of packets in the set of packets (z=k) that the retransmission logic circuitry of the transmitter is attempting to transmit to the receiver. The total decoding failure probability for each retransmission scheme is the decoding failure probability for the first retransmission multiplied by the decoding failure probability for each subsequent retransmission, taking into account the constraints and conditions for each subsequent retransmission.

The packet loss probability, \tilde{η}_{k,T}(g), for the first retransmission of each retransmission scheme may be the packet loss rate (eᵣ) for the transmission medium multiplied by the sum of the probabilities for each of the sub-strategies that the actual number of packets remaining to transmit to the retransmission logic circuitry of the receiver (Z₁) at the first sub-strategy, is equal to the number of packets to transmit (z) by each of the sub-strategies for the first retransmission multiplied by the failure probability of each sub-strategy (g_{k,z}) from one (z=1) to the number of packets in the set of packets (z=k) that the retransmission logic circuitry of the transmitter is attempting to transmit to the receiver. The total packet loss probability for each retransmission scheme is the packet loss probability for the first retransmission multiplied by the packet loss probability for each subsequent retransmission, taking into account the constraints and conditions for each subsequent retransmission.

In many embodiments, the recursive calculations for determining retransmission schemes may be divided into two different cases, a discrete case and a continuous case. For the discrete case, the complexities of the calculations may be reduced in an algorithm based on a determination that the time parameters T, τ, and d, are integer multiples of a unit time Δ. The retransmission logic circuitry may perform iterations of Pareto optimization for a data size k′ equal to 1 through k (e.g., 1, 2, 3, . . . k) and the time limit T′ equal to 1Δ through T (e.g., 1Δ, 2Δ, 3Δ, . . . T). Such embodiments are feasible unless the time constraint, T, cannot be split into equal integers of unit time or the unit time integer is so small that the number of iterations increases the computations beyond the computations required to perform the continuous case algorithm.

In a discrete case algorithm, when the time remaining is 1Δ, there is no time for receipt of feedback and a subsequent retransmission (no time for sub-strategies) so the function (g) for the retransmission strategy may set the first transmission to the number of network coded packets to transmit (x₁) equal to or less than the total time constraint T.

When the time remaining is 1Δ, the retransmission logic circuitry may determine all strategies from transmission of zero network coded packets to transmission of the time constraint (T) divided by the time to transmit a packet (T). This is true for the strategy and for sub-strategies of a retransmission scheme. The retransmission logic circuitry may then remove the non-optimal schemes by comparing performances. For instance, if the expected time usage for a first strategy is greater than or equal to the expected time usage for a second strategy, and the failure probability of the first strategy is greater than the failure probability of the second strategy, the first strategy is not optimal and should be removed. Similarly, if the expected time usage for a first strategy is greater than the expected time usage for a second strategy, and the failure probability of the first strategy is greater than or equal to the failure probability of the second strategy, the first strategy is not optimal and should be removed. The retransmission logic circuitry may iteratively perform a process of comparing performances of the strategies from the set of all strategies, S(k′,T′), to determine a set of Pareto optimal strategies, P(k′,T′).

When the time remaining is greater than 1Δ, there might be time remaining in the strategies after transmission of a first number of x₁ network coded packets for feedback and one or more subsequent transmission. In such embodiments, the retransmission logic circuitry of the transmitter may determine a sub-strategy for each possible number (z₁) of remaining packets that may still be needed by the retransmission logic circuitry of the receiver after the first transmission. from transmission of zero network coded packets to transmission of the time constraint (T) divided by the time to transmit a packet (τ). This is true for sub-strategies of each of the sub-strategies of a retransmission scheme until all the network coded packets have been received by the receiver or there is insufficient time for feedback and a subsequent transmission. The retransmission logic circuitry of the transmitter may iteratively perform the process to determine the set of all strategies, S(k′,T′) and then perform a process of comparing performance metrics (expected time usage and probability of failure) of the strategies from the set of all strategies, S(k′,T′), to determine a set of Pareto optimal strategies, P(k′,T′).

In the continuous case algorithm, when the time parameters are not integer multiples of a common unit time Δ or the common unit time is so small that the computational resources needed exceed those needed for the continuous case algorithm or are otherwise determined to be inefficient, the retransmission logic circuitry of the transmitter may use the continuous case algorithm for continuous time parameters. For the continuous time parameters, the retransmission logic circuitry may account for the total time consumed by packet transmission (Tₚₖₜ) and the total time consumed by feedback transmissions (T_{fb}). The total time consumed by packet transmissions is the total number of packets transmitted (nₚₖₜ) multiplied by the time for transmission of a packet (τ). The total time consumed by feedback transmissions is the total number of feedback frames transmitted (n_{fb}) multiplied by the sum (d) of the gap time and the feedback time. The total number of possible combinations of nₚₖₜ and n_{fb} is limited by constraints such as the time constraint (T) and the total number of packets (nₚₖₜ) should exceed or be equal to the total number of feedback frames transmitted (n_{fb}).

In many embodiments, the retransmission logic circuitry may compute the times for each of the complete retransmission strategies to generate a list of times, L(t), and may sort the list of times, L(t). In some embodiments, all sub-strategies that require more than the time remaining after the first transmission (T₁) are removed from the full set of strategies. Thereafter, many embodiments may optimize the full set of strategies by comparing performance metrics to generate a set of Pareto optimal strategies, P(k′,T′).

With the set of Pareto optimal strategies, P(k′,T′), the retransmission logic circuitry may select a retransmission scheme based on the reliability and spectral efficiency of the retransmission schemes. For instance, the reliability may require a minimum number of packets of the original set of k packets to be received and decoded by the retransmission logic circuitry of the receiver and the spectral efficiency may relate to the number of network coded packets transmitted to arrive at the reliability requirement. As another example, the retransmission logic circuitry may select retransmission schemes that meet a spectral efficiency requirement and select the retransmission scheme that maximizes the reliability within the retransmission schemes.

In some embodiments, the retransmission logic circuitry may further perform quantization-based thinning to reduce the number retransmission schemes in the set of Pareto optimal strategies, P(k′,T′). The retransmission logic circuitry may set a precision or granularity for distinction between different retransmission schemes and remove redundant retransmission schemes. In some embodiments, for instance, the retransmission logic circuitry may set a precision for reliability (such as a packet loss rate) to 0.1% and reduce the retransmission schemes by removing or otherwise not including retransmission schemes with the same spectral efficiency and less than 0.1% difference in reliability. In other embodiments, the retransmission logic circuitry may set a precision for spectral efficiency to 0.1% and/or reliability to 0.1%. In further embodiments, the precision may be greater or smaller for spectral efficiency and/or reliability such as 0.05%, 0.01%, 0.2%, 0.5%, 1%, 5%, and/or the like.

Embodiments may also comprise retransmission logic circuitry to facilitate communications by stations (STAs) in accordance with different versions of Institute of Electrical and Electronics Engineers (IEEE) 802.11 standards for wireless communications (generally referred to as “Wi-Fi”) such as IEEE 802.11-2020, December 2020; IEEE P802.11be™/D2.2, October 2022; IEEE P802.11ax-2021™, IEEE P802.11ay-2021™, IEEE P802.11az™/D3.0, IEEE P802.11ba-2021™, IEEE P802.11bb™/D0.4, IEEE P802.11bc™/D1.02, and IEEE P802.11bd™/D1.1.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

Various embodiments may be designed to address different technical problems associated with retransmission schemes. Currently packet-level network coding is not implemented in Wi-Fi system and selective retransmission with a block acknowledgement (BlockAck) policy used in A-MPDU scenario to improve reliability. Network coding with retransmissions has been used in other communication settings with various heuristic retransmission schemes. However, such schemes transmit the exact number x of missing packets reported by the receiver, or over-provision by transmitting x/(1−eᵣ) packets, accounting for the packet loss rate eᵣ.

Different technical problems such as those discussed above may be addressed by one or more different embodiments. Embodiments may address one or more of these problems associated with retransmission schemes. For instance, some embodiments that address problems associated with retransmission schemes may do so by one or more different technical means, such as, determining a first set of packets for transmission to a second STA in an aggregated medium access control (MAC) protocol data unit (A-MPDU); identifying a retransmission scheme generated based on a time constraint, the retransmission scheme to determine a first number of packets to transmit based on the first set of packets; generating one or more network coded packets of a pool of network coded packets for transmission in the A-MPDU, wherein the one or more network coded packets comprise encoded combinations of the first set of packets; generating the A-MPDU for transmission to the second STA with the first number of packets, the first number of packets comprising at least one of the one or more network coded packets from the pool of network coded packets; and causing transmission of the A-MPDU to the second STA; and/or the like. In some embodiments, to address the problems, the one or more network coded packets may be linearly independent. In some embodiments, to address the problems, the one or more network coded packets comprise linear combinations of the first set of packets encoded with linear packet-level coding having a maximum distance separable (MDS) property. In some embodiments, to address the problems, the first number of network code packets comprises the first set of packets in addition to the one or more network coded packets. In some embodiments, to address the problems, the logic circuitry to further receive a block acknowledgement (BlockAck) comprising a feedback value, wherein the feedback value is a number of additional network coded packets requested by the second STA to decode the first set of packets or a number of packets received by the second STA. In some embodiments, to address the problems, the feedback value provides no indication of which packets have been received by the second STA and no indication of which packets are being requested by the second STA. In some embodiments, to address the problems, the logic circuitry may further: determine a second number of packets based on a first sub-scheme of the retransmission scheme and based on the feedback value; cause transmission of the second number of packets in a second A-MPDU; and receive a second BlockAck comprising a second feedback value if sufficient time remains to receive the second BlockAck. In some embodiments, to address the problems, the logic circuitry may further: repeatedly cause transmission, in accordance with a corresponding sub-scheme of the retransmission scheme, wherein a number of network coded packets in the pool of network coded packets selected for transmission for each of the sub-schemes is a function of a corresponding feedback value received from the second STA and a time remaining for the retransmission scheme; and repeatedly receive BlockAcks from the second STA, if sufficient time remains to receive the BlockAcks, wherein each of the BlockAcks comprises the corresponding feedback value, wherein the corresponding feedback value is a number of additional network coded packets requested by the second STA to decode the first set of packets or a number of packets received by the second STA. In some embodiments, to address the problems, the logic circuitry may further select a process by which to compute the retransmission scheme, the process comprising a discrete process or a continuous process, the logic circuitry to select the discrete process if a transmission time for one of the one or more network coded packets and a sum of a feedback time and a gap time are multiples of a common unit time. In some embodiments, to address the problems, the logic circuitry may further determine a set of potentially optimal schemes based on the time constraint, a packet loss rate, a feedback time, and a gap time; and identify the retransmission scheme from the set of potentially optimal schemes. Some embodiments that address problems associated with retransmission schemes may do so by one or more different technical means, such as, receiving a first number of packets from a first STA in an aggregated medium access control (MAC) protocol data unit (A-MPDU), the first number of packets comprising network coded packets for a retransmission scheme; decoding the first number of packets in accordance with a network coding scheme associated with the retransmission scheme, to determine one or more packets of a first set of packets; determining a feedback value, wherein the feedback value is a number of additional network coded packets to decode the first set of packets or a number of packets received by the second STA; generating the block acknowledgement (BlockAck) comprising the feedback value; and causing transmission of the BlockAck to the first STA; and/or the like.

Several embodiments comprise central servers, access points (APs), and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, and the like), and the like.

Some embodiments may facilitate wireless communications in accordance with multiple standards. Some embodiments may comprise low power wireless communications like Bluetooth®, cellular communications, and messaging systems. Furthermore, some wireless embodiments may incorporate a single antenna while other embodiments may employ multiple antennas or antenna elements.

While some of the specific embodiments described below will reference the embodiments with specific configurations, those of skill in the art will realize that embodiments of the present disclosure may advantageously be implemented with other configurations with similar issues or problems.

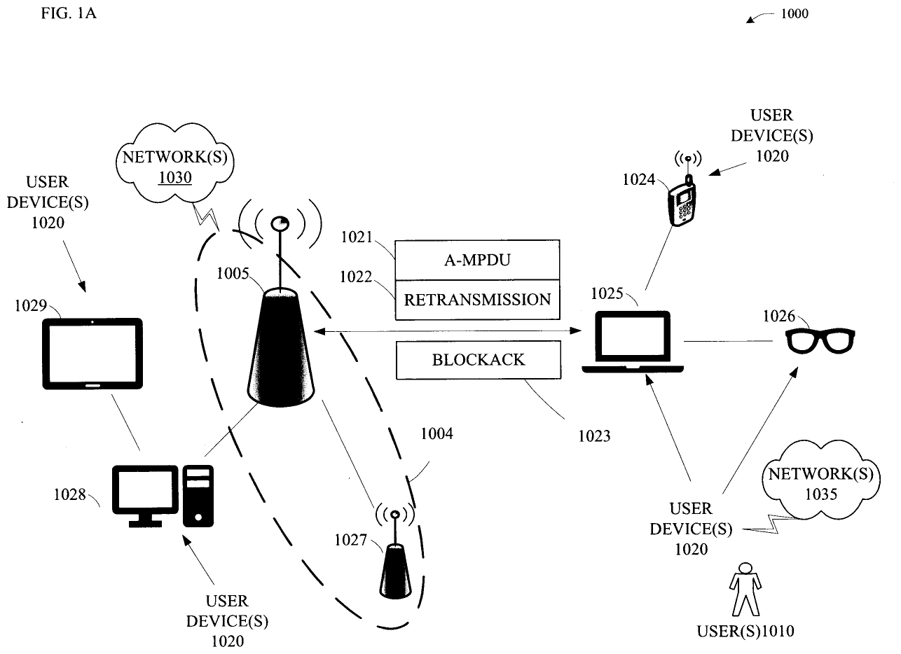

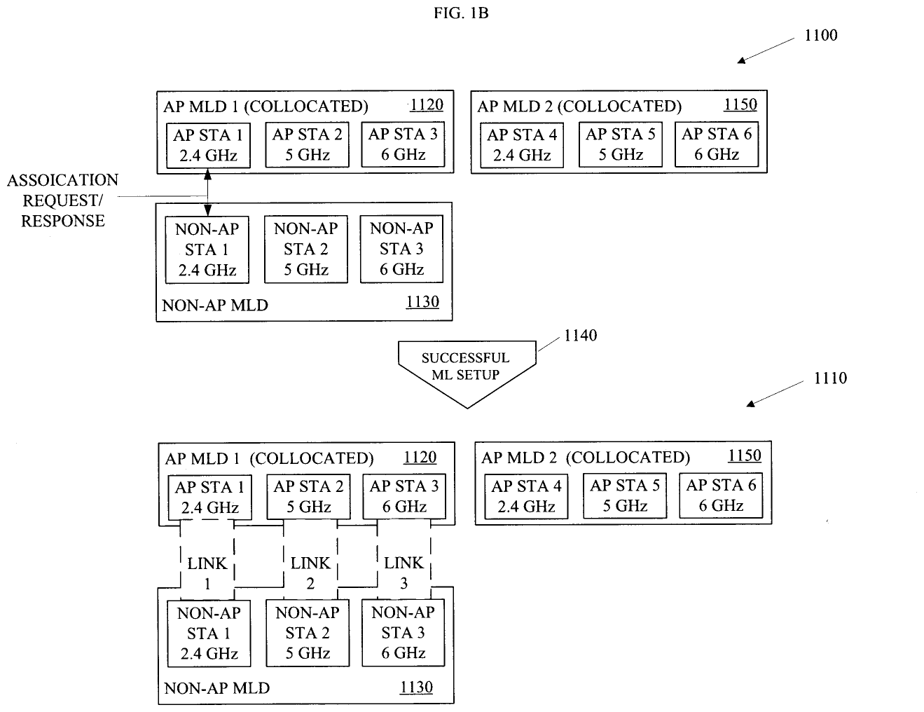

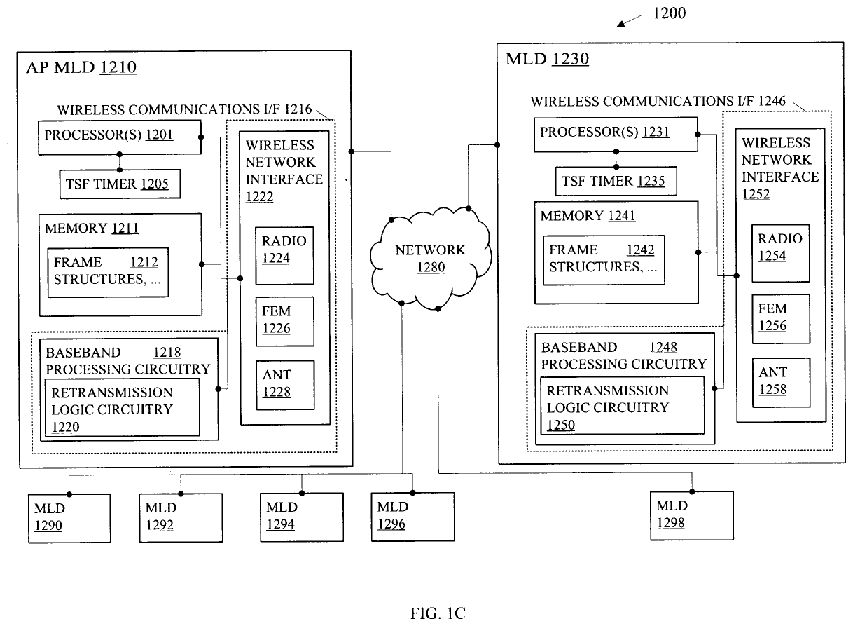

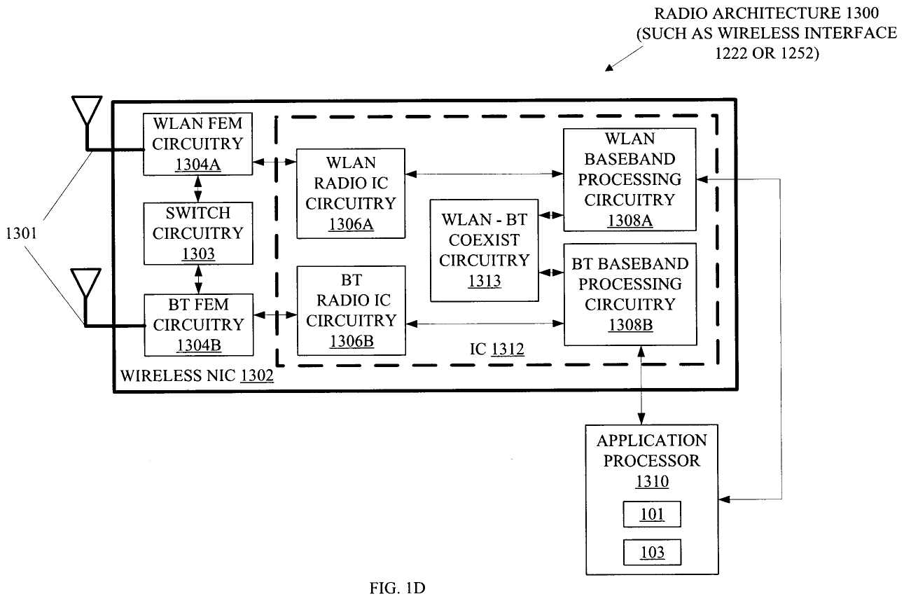

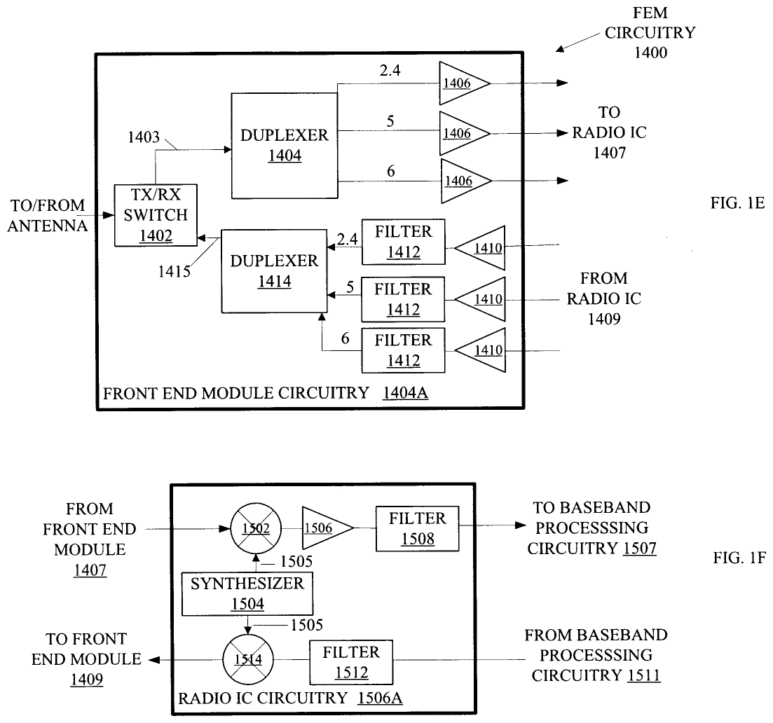

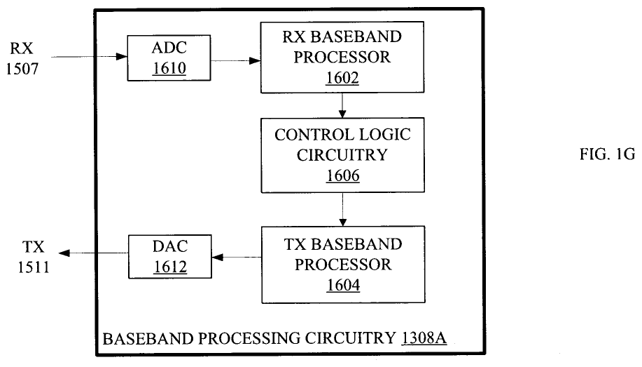

FIG. 1A depicts a system diagram illustrating an embodiment of a network environment for retransmission logic circuitry, in accordance with one or more example embodiments. Wireless network 1000 may include one or more access point (AP) multi-link devices (AP-MLDs) 1005 and 1027, and one or more user devices 1020 (non-AP MLDs), which may communicate in accordance with IEEE 802.11 communication standards. Note that while IEEE 802.11 communication standards an MLDs are discussed in many embodiments, embodiments are not limited to any particular standards or Wi-Fi devices. Embodiments may be incorporated in any wireless communications and any wireless communication devices including single band devices, dual band devices, tri-band devices, and other multiple band devices, in addition to MLDs. Note also that differences between the multiple band devices and MLDs may include an added layer of management such as a ML management entity to add more coordination between communications across links on multiple bands and a STA management entity for each band to manage communications for each band. Whereas a multiple band device may have a single STA management entity capable of managing communications on a selectable band of the multiple bands.

In the present embodiment, the AP MLD 1005 may comprise a collocated set of AP stations (STAs) and the AP MLD 1027 may comprise a collocated set of AP STAs communicatively connected via a backhaul and/or network(s) 1030. Furthermore, the AP MLD 1005 and AP MLD 1027 may be affiliated with the same basic service set (BSS) 1004.

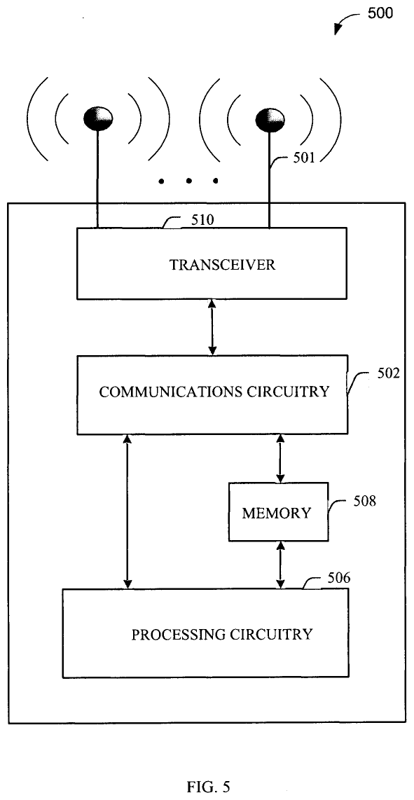

The user device(s) 1020 may comprise mobile devices that are non-stationary (e.g., not having fixed locations) and/or stationary devices. In some embodiments, the user device(s) 1020 and the AP-MLDs 1005 and 1027 may include one or more computer systems similar to the STAs shown in FIGS. 1B-1G and/or the example machine/system of FIGS. 5, 6, 7, and 8.

One or more illustrative user device(s) 1020 and/or AP-MLDs 1005 and 1027 may be operable by one or more user(s) 1010. It should be noted that any addressable unit may be a station (STA). A STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 1020 and the AP-MLDs 1005 and 1027 may include STAs. The one or more illustrative user device(s) 1020 and/or AP-MLDs 1005 and 1027 may operate as an extended service set (ESS), a basic service set (BSS), a personal basic service set (PBSS), or a control point/access point (PCP/AP).

The user device(s) 1020 (e.g., 1024, 1025, 1026, 1028, or 1029) and/or AP-MLDs 1005 and 1027 may include any suitable processor-driven device including, but not limited to, a mobile device or a non-mobile, e.g., a static device. For example, user device(s) 1020 and/or AP-MLDs 1005 and 1027 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless network interface, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

In some embodiments, the user device(s) 1020 and/or AP-MLDs 1005 and 1027 may also include mesh stations in, for example, a mesh network, in accordance with one or more IEEE 802.11 standards and/or 3GPP standards.

Any of the user device(s) 1020 (e.g., user devices 1024, 1025, 1026, 1028, and 1029) and AP-MLDs 1005 and 1027 may be configured to communicate with each other via one or more communications networks 1030 and/or 1035 wirelessly or wired. In some embodiments, the user device(s) 1020 may also communicate peer-to-peer or directly with each other with or without the AP-MLDs 1005 and 1027 and, in some embodiments, the user device(s) 1020 may also communicate peer-to-peer if enabled by the AP-MLDs 1005 and 1027.

In the present embodiment, the AP-MLDs 1005 and 1027 may comprise 2.4 GHz, and 6 GHz STAs. Note that embodiments are not limited to STAs capable of any particular set of carrier frequencies and the STAs of AP MLDs are not required to have sets of STAs with the same carrier frequencies.

Furthermore, the user device(s) 1020 (e.g., user devices 1024, 1025, 1026, 1028, and 1029) and AP-MLDs 1005 and 1027 may each comprise retransmission logic circuitry to implement retransmission schemes. While the functionality of the retransmission logic circuitry of the incorporated of the user device(s) 1020 (e.g., user devices 1024, 1025, 1026, 1028, and 1029) and AP-MLDs 1005 and 1027 may include all the functionality discussed herein for retransmission logic circuitry in some embodiments; in other embodiments, some of the user device(s) 1020 (e.g., user devices 1024, 1025, 1026, 1028, and 1029) and AP-MLDs 1005 and 1027 may only incorporate some of the functionality.

In the present embodiment, the retransmission logic circuitry of the user device 1025 may associate with the AP-MLD 1005 based on inclusion of the AP-MLD 1005 in the BSS 1004 and the connection of the BSS 1004 with a user device 1028 to establish a data stream between the user device 1028 and the user device 1025. During the association, the user device 1025 and the AP-MLD 1005 may exchange capabilities including a capability to perform retransmission schemes. For instance, the user device 1025 may indicate a capability to perform retransmission schemes with one or more bits in a MAC frame such as an association request frame, a probe request frame, and/or the like. In some embodiments, the user device 1025 may also indicate a capability to decode one or more network coding schemes.

In some embodiments, the AP-MLD 1005 may include one or more bits in a MAC frame such as a beacon frame, a probe response frame, an association response frame, and/or the like to indicate a capability to perform retransmission schemes and, in some embodiments, one or more bits to indicate a capability to implement one or more network coding schemes in conjunction with the retransmission schemes. In some embodiments, the AP-MLD 1005 may assess or measure a packet loss rate during communications with the user device 1025.

In some embodiments, the user device 1025 and the AP-MLD 1005 may negotiate a reliability and/or spectral efficiency for the communications between the user device 1025 and the AP-MLD 1005. In some embodiments, the AP-MLD 1005 may have default settings for reliability and/or spectral efficiency and, in some embodiments, the AP-MLD 1005 may have default settings for a minimum reliability and/or a minimum spectral efficiency.

In some embodiments, the user device 1025 and the AP-MLD 1005 may negotiate a network coding scheme to implement the retransmission schemes. In other embodiments, the network coding scheme may be known by both the user device 1025 and the AP-MLD 1005.

The retransmission logic circuitry of the AP-MLD 1005 may reside, at least in part, in the MAC layer of the AP MLD 1005 and may receive data in a time-sensitive data stream from a user device 1028 to transmit to the user device 1025. The retransmission logic circuitry of the AP-MLD 1005 may determine a time-constraint for transmission of sets of packets including the data from the data stream based on, e.g., a quality of service (QoS) parameter for the data stream and may also determine a first set of packets to transmit to the user device 1025. The retransmission logic circuitry of the AP-MLD 1005 may determine a full set of retransmission schemes based on a reliability, spectral efficiency, and packet loss rate (or error rate) associated with communications with the user device 1025.

After determining the full set of retransmission schemes, the retransmission logic circuitry of the AP-MLD 1005 may determine an optimal set of retransmission schemes by comparing estimated metrics for the schemes against one another and removing retransmission schemes that are not optimal. For instance, the retransmission logic circuitry of the AP-MLD 1005 may compare the expected time usage, probability of failure, and the packet loss probabilities of the retransmission scheme to remove retransmission schemes that have the same expected time usage but greater probabilities of failure than other retransmission schemes or that have the same probability of failure but greater expected time usages than other retransmission schemes.

Once the retransmission logic circuitry of the AP-MLD 1005 determines the optimal set of retransmission schemes, the retransmission logic circuitry of the AP-MLD 1005 may sort or otherwise process the optimal retransmission schemes to select one of the optimal retransmission schemes based on the reliability and/or spectral efficiency associated with communications with the user device 1025. For instance, the retransmission logic circuitry of the AP-MLD 1005 may select the retransmission scheme from the optimal retransmission schemes based on the scheme with the lowest expected time usage or with the highest reliability.

The retransmission logic circuitry of the AP-MLD 1005 may also begin generation of a pool of network coded packets. In some embodiments, the retransmission logic circuitry of the AP-MLD 1005 may determine the size of the pool of network coded packets based on the maximum number of network coded packets that might be required for the selected retransmission scheme. In further embodiments, the retransmission logic circuitry of the AP-MLD 1005 may generate network coded packets of the pool for the selected retransmission scheme as needed for (just before or while preparing to cause transmission of) the first transmission and as needed for (just before or while preparing to cause transmission of) each subsequent retransmission of data to the user device 1025.

In many embodiments, the retransmission logic circuitry of the AP-MLD 1005 may determine or receive the data as a set of k equal size packets. In some embodiments, the retransmission logic circuitry of the AP-MLD 1005 may then perform network coding to encode the set of k equal size packets to generate network coded packets. Depending on the network coding selected for encoding the network coded packets, up to k network coded packets may linearly independent. Thus, the retransmission logic circuitry of the AP-MLD 1005 may encode network coded packets such that any subset of up to k network coded packets in the pool of network coded packets may be linearly independent packets.

For example, If k=5 and n=10. The original set of packets includes 5 packets and the pool of network coded packets includes 10 packets. In other words, 5 packets are encoded into 10 network coded packets and the retransmission logic circuitry of the AP MLD 1005 may index the network coded packets 1-10. If the network code is maximum distance separable (MDS), then any subset of size 5 network coded packets is linearly independent. For instance, any set of network coded packets with arbitrary distinct indices (a,b,c,d,e where a,b,c,d, and e represent the different indices of the indices 1-10) are linearly independent, regardless of the values of these indices. To illustrate, (a,b,c,d,e) can be (1,3,4,7,10), or any other set of 5 network coded packets with distinct indices. If we add one more index f to the set, then the network coded packets (a,b,c,d,e,f) are not all linearly independent.

For non-MDS network codes, the 5 distinct packets (a,b,c,d,e) may or may not be linearly independent but 6 network coded packets of the non-MDS network coded packets are not all linearly independent.

Thus, if the retransmission logic circuitry of the AP MLD 1005 forms a pool of 10 network coded packets, then the network coded packets are not all linearly independent. Many embodiments herein do not need them to be all linearly independent. Instead, since some of the packets may be lost, many embodiments may only need to receive 5 that are linearly independent to be able to decode 5 of the network coded packets and recover the original set of 5 packets. MDS coding may be advantageous in the sense that as long as 5 (where k=5) network coded packets are received, the 5 network coded packets are guaranteed to be independent, facilitating successful decoding of the 5 network coded packets.

The retransmission logic circuitry of the AP-MLD 1005 may also generate linear combinations of the set of k equal size packets to generate one or more network coded packets for the pool of network coded packets such that any subset of k or less network coded packets are linearly independent. For instance, the network coding may generate linear combinations of the set of k equal size packets with linear packet-level coding having a MDS property. Based on the linearly independent coding of the network coded packets, the user device 1025 may, advantageously, decode the entire set of k equal size packets after receipt of k network coded packets. In many embodiments, the retransmission logic circuitry of the AP-MLD 1005 may also systematically encode the network coded packets in accordance with the network coding scheme, whether negotiated or set by the retransmission logic circuitry of the AP-MLD 1005, so that the retransmission logic circuitry of the user device 1025 can decode the network coded packets for the selected retransmission scheme with knowledge of the network coding scheme.

The selected retransmission scheme may identify the first number of network encoded packets (x₁) to include in the first transmission of the data from the AP-MLD 1005 to the user device 1025. After selection of the retransmission scheme, the retransmission logic circuitry of the AP-MLD 1005 may generate a MAC A-MPDU 1021 comprising the first number of network coded packets in the payload of A-MPDU subframes of the MAC A-MPDU 1021. In some embodiments, each A-MPDU subframe may comprise one network coded packet. In further embodiments, each A-MPDU subframe may include more than one network coded packets.

In many embodiments, the MAC A-MPDU 1021 may include one or more bits to indicate the number of packets (k) in the set of k equal size packets of the data and may include a header with an Ack policy field comprising one or more bits to indicate the block acknowledgement policy for the A-MPDU 1021. For instance, in some embodiments, the A-Control subfield in the A-MPDU subframe of the MAC A-MPDU 1021 may include information that is required for the network coding scheme. The content of the A-Control subfield of each A-MPDU subframe may be different between A-MPDU subframes. In some embodiments, the A-Control field may include a network coding (NC) code type (e.g., Reed-Solomon encoder with encoding matrix C{ij}), a number of data packets (k), a number of parity packets (n−k), a packet index after the NC encoding, and/or the like. In some embodiments, NC encoding may reside in the frame body subfield of an MPDU rather than residing in the MAC header, FCS, or the MPDU delimiter and padding fields of the A-MPDU subframe.

In some embodiments, if there is sufficient time remaining within the time constraint for transmission of the data to the user device 1025 for feedback and/or for feedback and a retransmission 1023, the retransmission logic circuitry of the AP-MLD 1005 may include one or more bits in the Ack policy field to request an immediate block acknowledgement (BlockAck). In some embodiments, the immediate BlockAck is always requested and the retransmission logic circuitry of the user device 1025 may determine if sufficient time remains within the time constraint to transmit the feedback and/or the feedback and retransmission.

Upon receipt of the MAC A-MPDU from the AP-MLD 1005, the retransmission logic circuitry of the user device 1025 may decode the network coded packets. If there is time within the time constraint to respond with a BlockAck 1023 and receive a retransmission 1022, the retransmission logic circuitry of the user device 1025 may to determine a feedback value by counting the number of network coded packets received, counting the number of network coded packets decoded, determining the number of network coded packets that the user device 1025 still needs to receive to receive the entire set of k equal size packets, determining the number of network coded packets that the user device 1025 still needs to decode to decode the entire set of k equal size packets, and/or the like. Note that the feedback value may comprise or indicate a number of network coded packets and does not include or indicate, in many embodiments, which packets were received. Inclusion of the number of packets or an indication of the number without including a bitmap to indicate which packets were received or not received, may advantageously reduce the size of the BlockAck. Reducing the size or average size of the BlockAck may, advantageously, increase the spectral efficiency of feedback for the transmission, increase the spectral efficiency of feedback on average for the first transmission and all the retransmissions, and/or increase the spectral efficiency of feedback in an overall average for implementation of the retransmission scheme.

When time permits within the time constraint, the retransmission logic circuitry of the user device 1025 may generate a BlockAck 1023 including the feedback value and cause transmission of the BlockAck 1023 to the AP-MLD 1005. Note that if there is not enough time within the time constraint for the retransmission scheme to send the BlockAck 1023 and receive a retransmission 1022, the retransmission logic circuitry of the user device 1025 may, advantageously, not send feedback to increase the spectral efficiency of the retransmission scheme. In some embodiments, the retransmission logic circuitry of the user device 1025 may only respond with a BlockAck 1023 if the A-MPDU includes a request for an immediate BlockAck in the Ack policy field. In some embodiments, the retransmission logic circuitry of the user device 1025 may respond with a BlockAck 1023 if there is sufficient time for transmitting the BlockAck.

Upon receipt of the BlockAck 1023 from the user 1025, the retransmission logic circuitry of the AP-MLD 1005 may determine the feedback value and may select a sub-strategy of the selected retransmission scheme based on the feedback value. Note that the selected retransmission scheme includes a sub-strategy for each possible feedback value for the first retransmission after the first transmission, and for each possible retransmission after the first retransmission.

The sub-strategy may include the number of network coded packets from the pool of network coded packets to include in the first retransmission 1022. After selecting the sub-strategy, the retransmission logic circuitry of the AP-MLD 1005 may generate (if not already generated) network coded packets for the first retransmission 1022 and cause transmission of the network coded packets in A-MPDU subframes of an A-MPDU to the user device 1025. If there is sufficient time remaining in the time constraint for the selected retransmission strategy for receipt of a BlockAck and a subsequent retransmission, the retransmission logic circuitry of the AP-MLD 1005 may include one or more bits in the Ack policy field of the A-MPDU to indicate a request for an immediate BlockAck. Otherwise, the retransmission logic circuitry of the AP-MLD 1005 may include one or more bits in the Ack policy field of the A-MPDU to indicate no request for a BlockAck.

Upon receipt of the MAC A-MPDU in the first retransmission 1022 from the AP-MLD 1005, the retransmission logic circuitry of the user device 1025 may decode the network coded packets for the first retransmission 1022. Note that the network coded packets may be encoded with a network coding known to the retransmission logic circuitry of the user device 1025 due to the systematic encoding. If there is time within the time constraint to respond with a BlockAck and receive another retransmission, the retransmission logic circuitry of the user device 1025 may determine the feedback value, which, as described above, is a number of network coded packets received or decoded, and cause transmission of the BlockAck to the AP-MLD 1005.

Note that this iterative process of communicating A-MPDUs in retransmissions and BlockAcks with feedback values continues until the retransmission logic circuitry of the user device 1025 receives k network coded packets, decodes the entire set of k equal size packets, or insufficient time remains to transmit feedback in a BlockAck and/or receive another retransmission. For the AP-MLD 1005, the process continues until the sub-strategies are exhausted, insufficient time remains for further retransmission within the time constraint, or the retransmission logic circuitry of the AP-MLD 1005 receives a feedback value that indicates that the user device 1025 received all the network coded packets needed to decode the entire set of k equal size data packets. For instance, the feedback value in the BlockAck 1023 may indicate the value k to indicate that k network coded packets have been received or may indicate the value zero to indicate that zero more network coded packets are requested.

Note that once the retransmission scheme is selected for transmission of data to the user device 1025, the retransmission logic circuitry of the AP-MLD 1005 may continue to use selected retransmission scheme for subsequently received data to transmit to the user device 1005. The retransmission logic circuitry of the AP-MLD 1005 may, in some embodiments, select a new retransmission scheme if parameters such as the packet loss rate for communication through the channel changes significantly (e.g., by 10%, 20%, 30% or the like) or the parameters for the reliability and/or spectral efficiency change significantly (e.g., by 10%, 20%, 30% or the like).

Any of the communications network(s) 1030 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 1030 and/or 1035 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 1030 and/or 1035 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 1020 (e.g., user devices 1024, 1025, 1026, 1028, and 1029), the AP MLD 1005, and the AP-MLD 1027 may include one or more communications antennas. The one or more communications antennas may be any suitable type of antennas corresponding to the communications protocols used by the user device(s) 1020 (e.g., user devices 1024, 1025, 1026, 1028, and 1029) and AP-MLD 1005. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 1020, AP MLD 1005, and/or AP-MLD 1027.

Any of the user device(s) 1020 (e.g., user devices 1024, 1025, 1026, 1028, and 1029), the AP MLD 1005, and AP-MLD 1027 may be configured to wirelessly communicate in a wireless network. Any of the user device(s) 1020 (e.g., user devices 1024, 1025, 1026, 1028, and 1029), the AP MLD 1005, and AP-MLD 1027 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 1020 (e.g., user devices 1024, 1025, 1026, 1028, and 1029), the AP MLD 1005, and AP-MLD 1027 may be configured to perform any given directional transmission towards one or more defined transmit sectors. Any of the user device(s) 1020 (e.g., user devices 1024, 1025, 1026, 1028, and 1029), the AP MLD 1005, and AP-MLD 1027 may be configured to perform any given directional reception from one or more defined receive sectors.

MIMO beamforming in a wireless network may be accomplished using RF beamforming and/or digital beamforming. In some embodiments, in performing a given MIMO transmission, user devices 1020, AP MLD 1005, and/or AP-MLD 1027 may be configured to use all or a subset of its one or more communications antennas to perform MIMO beamforming.

Any of the user devices 1020 (e.g., user devices 1024, 1025, 1026, 1028, and 1029), the AP MLD 1005, and AP-MLD 1027 may include any suitable radio and/or transceiver for transmitting and/or receiving radio frequency (RF) signals in the bandwidth and/or channels corresponding to the communications protocols utilized by any of the user device(s) 1020 and AP-MLD 1005 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax, 802.11be), 5 GHz channels (e.g., 802.11n, 802.11ac, 802.11ax, 802.11be), 6 GHz (e.g., 802.11be), or 60 GHz channels (e.g., 802.11ad, 802.11 ay, Next Generation Wi-Fi) or 800 MHz channels (e.g., 802.11ah). The communications antennas may operate at 28 GHz, 40 GHz, or any carrier frequency between 45 GHz and 75 GHz. It should be understood that this list of communication channels in accordance with certain 802.11 standards is only a partial list, and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a power amplifier (PA), a low noise amplifier (LNA), additional signal amplifiers, an analog-to-digital (A/D) converter, one or more buffers, and a digital baseband.

FIG. 1B depicts an embodiment 1100 illustrating interactions between stations (STAs) to associate a non-access point (AP) multilink (ML) device (non-AP MLD) 1130 with an access point (AP) multilink (ML) device (AP MLD) 1120 via multiple links or channels on multiple bands. The AP MLD 1120 has three collocated affiliated AP STAs: AP STA 1 operates on 2.4 GHz band, AP STA 2 operates on 5 GHz band, and AP STA 3 operates on 6 GHz band. The pre-association state 1100 depicts the non-AP MLD 1120 without links. The post-association state 1110 depicts the non-AP MLD 1120 with links set up.

The non-AP STA 1 affiliated with the non-AP MLD 1130 sends an association request frame (or a reassociation request frame) to AP STA 1 affiliated with the AP MLD 1120. The association request frame may have a TA field set to the MAC address of the non-AP STA 1 and an RA field set to the MAC address of the AP STA 1. The association request frame may include complete information of non-AP STA 1, non-AP STA 2, and non-AP STA 3 to request links to be setup (one link between AP STA 1 and non-AP STA 1, one link between AP STA 2 and non-AP STA 2, and one link between AP STA 3 and non-AP STA 3) and a ML element that indicates the MLD MAC address of the non-AP MLD 1130.

In some embodiments, the association request frame may include a capability information field or other capabilities field that includes one or more bits to indicate a capability for retransmission schemes such as a Pareto optimal network coding retransmission scheme. In some embodiments, the capability information field or other capabilities field may also include one or more subfields to indicate specific capabilities such as capabilities for one or more different network encoding schemes, for a time constrained retransmission scheme, for a BlockAck with a feedback value rather than a bitmap, for associating the retransmission scheme capabilities with one or more of links of the non-AP MLD 1130, and/or the like. In some embodiments, one or more of the capabilities associated with the non-AP MLD 1130 are negotiable.

For instance, during the association process, the AP MLD 1120 may establish communications protocols including identification of any parameters that differ from default parameters, preferential communications protocols, and/or negotiate communications protocols for the links. In some embodiments, for instance, the AP MLD 1120 may exchange capabilities with the non-AP MLD 1130 to negotiate the establishment of a Pareto-optimal time-limited network coding retransmission scheme. In some embodiments, the non-AP MLD 1130 may maintain a definition of MAC-level network coding schemes for Pareto-optimal time-limited network coding retransmission. In other embodiments, the AP MLD 1120 may provide the non-AP MLD 1130 with a definition of MAC-level network coding schemes for Pareto-optimal time-limited network coding retransmission. In further embodiments, the non-AP MLD 1130 may provide the AP MLD 1120 with a definition of MAC-level network coding schemes for Pareto-optimal time-limited network coding retransmission. In still further embodiments, the non-AP MLD 1130 may provide an indication of MAC-level network coding schemes for Pareto-optimal time-limited network coding retransmission in a capabilities element that the non-AP MLD 1130 transmits to the AP MLD 1120. In still other embodiments, the AP MLD 1120 may provide an indication of MAC-level network coding schemes for Pareto-optimal time-limited network coding retransmission in a capabilities element that the AP MLD 1120 transmits to the non-AP MLD 1130.

AP STA 1, affiliated with the AP MLD 1 1120, may send an association response frame to non-AP STA 1 affiliated with the non-AP MLD 1130 with a TA field of the association response frame is set to the MAC address of the AP STA 1, an RA field of the association response frame set to the MAC address of the non-AP STA 1, and link IDs in the per-STA profile subelements of an ML element of the association response frame determined for the association of the non-AP MLD 1130, to indicate successful ML setup 1140. In some embodiments, where the non-AP MLD 1130 requests association with only STAs of the collocated MLD 1 1120, the link IDs may be same link IDs associated with the AP STAs 1, 2, and 3 for the links 1, 2, and 3 with the non-AP STAs 1, 2, and 3 of the non-AP MLD 1130. The association response frame may include complete information of AP STA 1, AP STA 2, and AP STA 3 and an ML element that indicates the MLD MAC addresses of the AP STAs 1, 2, and 3 of the AP MLD 1 1120 and values of the link IDs for the links 1, 2, and 3. After successful ML setup between the non-AP MLD 1130 and the AP MLD 1 1120, three links are setup (LINK 1 between AP 1 and non-AP STA 1, LINK 2 between AP 2 and non-AP STA 2, and LINK 3 between AP STA 3 and non-AP STA 3) as shown in the post association state 1110.

In some embodiments, the association response frame may include a capability information field or other capabilities field that includes one or more bits to indicate a capability for retransmission schemes such as a Pareto optimal network coding retransmission scheme. In some embodiments, the capability information field or other capabilities field may also include one or more subfields to indicate specific capabilities such as capabilities for one or more different network encoding schemes, for a time constrained retransmission scheme, for a BlockAck with a feedback value rather than a bitmap, for associating the retransmission scheme capabilities with one or more of links of the AP MLD 1120, and/or the like. In some embodiments, the AP MLD 1120 may negotiate one or more of the capabilities associated with retransmission schemes by inclusion of capabilities that match one or more of the capabilities indicated in the association response frame received from the non-AP MLD 1130. In some embodiments, the AP MLD 1120 may determine a packet loss rate (or error rate) for communications with the non-AP MLD 1130 during and/or after the association process. For instance, the non-AP MLD 1130 may determine a packet loss rate during and/or after exchange of the retransmission scheme capabilities for one or more links and transmit the packet loss rate to the AP MLD 1120. In further embodiments, the AP MLD 1120 may determine a packet loss rate for one or more of the links with the non-AP MLD 1130 based on communications during and/or after the exchange of the retransmission scheme capabilities for one or more links.

In some embodiments, the non-AP MLD 1130 may associate with less than all the links available from the AP MLD 1 1120 for various reasons. For instance, in some embodiments, the non-AP MLD 1130 may only be capable of establishing two of the links.

In some embodiments, the non-AP MLD 1130 may establish a link between non-AP STA 3 and AP STA 6 of the collocated AP MLD 2 1150 of the non-collocated AP MLD 3 1160 because, e.g., the AP STA 6 may have a better signal-to-noise ratio than the signal-to-noise ratio of the channel with the AP STA 3 of AP MLD 1 1120. In such circumstances, the non-AP MLD 1130 may include a per-STA profile element in the association request frame that includes a link ID associated with the AP STA 6 and a MAC address of the AP STA 6 of the AP MLD 2 1150. The AP STA 1 may generate the association response frame with a new link ID created for the AP STA 6 of the AP MLD 2 1150.

FIG. 1C depicts an embodiment of a system 1200 including multiple MLDs to implement retransmission logic circuitry, in accordance with one or more example embodiments. System 1200 may transmit or receive as well as generate, decode, and interpret transmissions between an AP MLD 1210 and multiple MLDs 1230, 1290, 1292, 1294, 1296, and 1298, associated with the AP MLD 1210. The AP MLD 1210 may be wired and wirelessly connected to each of the MLDs 1230, 1290, 1292, 1294, 1296, and 1298.

In some embodiments, the AP MLD 1210 may be one of multiple AP MLDs affiliated with a collocated AP MLD (not shown) and MLD 1230 may include one or more computer systems similar to that of the example machines/systems of FIGS. 5, 6, 7, and 8.

Each MLD 1230, 1290, 1292, 1294, 1296, and 1298, including the AP MLD 1210 may include retransmission logic circuitry, such as the retransmission logic circuitry 1250 of MLD 1230 and the retransmission logic circuitry 1220 of AP MLD 1210, to perform network coded retransmission schemes under a time constraint such as a transmission opportunity (TxOP) on, e.g., a 6 GHz channel.

The AP MLD 1210 may and each of the MLDs 1230, 1290, 1292, 1294, 1296, and 1298 may exchange capability information to establish the retransmission schemes on one or more links of the MLDs including the 6 GHz channel. After the association process, the AP MLD 1210 may receive periodic, aperiodic, and/or unscheduled data streams for each of the MLDs 1230, 1290, 1292, 1294, 1296, and 1298. Upon receipt of a data stream for one or more of the MLDs 1230, 1290, 1292, 1294, 1296, and 1298, the retransmission logic circuitry 1220 of AP MLD 1210 may perform network coding of a stream of k packets to obtain a stream of n network coded packets with systematic network coding. Systematic network coding may concatenate the k input data blocks with the n linear combinations of the k input data blocks generated at a coding rate of k/(k+n) to create a pool of k plus n network coded data blocks.

The retransmission logic circuitry 1220 of AP MLD 1210 may determine a retransmission scheme based on a time constraint for transmission of the data stream to one or more of the MLDs 1230, 1290, 1292, 1294, 1296, and 1298, a packet loss rate associated with the links for the one or more of the MLDs 1230, 1290, 1292, 1294, 1296, and 1298, and a reliability performance metric and/or a spectral efficiency performance metric. In some embodiments, the AP MLD 1210 may determine a different retransmission scheme for each link. For instance, if the time constraints, packet loss rates, reliability performance metrics, and/or spectral efficiency metrics differ significantly between different links associated with the same MLD, the AP MLD 1210 may determine a different retransmission scheme for each link associated with the same MLD. Similarly, if the time constraints, packet loss rates, reliability performance metrics, and/or spectral efficiency metrics differ significantly between different links associated with the different MLDs, the AP MLD 1210 may determine a different retransmission scheme for each link for each MLD. Significantly different parameters such as time constraints, packet loss rates, reliability performance metrics, and/or spectral efficiency metrics may be parameters that differ enough to change the performance of the retransmission schemes, which may change identification of optimal retransmission schemes based on, e.g., the estimated time usage, failure probability, and packet loss probability, and/or change the selection of the retransmission scheme from the set of optimal retransmission schemes.

After selecting one or more retransmission schemes for the one or more of the MLDs 1230, 1290, 1292, 1294, 1296, and 1298, the retransmission logic circuitry of the AP MLD 1210 may cause transmission of a first number of network coded packets from the AP MLD 1210 to the one or more of the MLDs 1230, 1290, 1292, 1294, 1296, and 1298, in the first round of transmission, in accordance with the corresponding retransmission scheme. For instance, if different transmission schemes are selected for the different links, each of the different retransmission schemes may define a different number of network coded packets to transmit to during the first transmission as well as during a first and subsequent retransmissions.

After transmission of the first number of network coded packets, the one or more of the MLDs 1230, 1290, 1292, 1294, 1296, and 1298 may receive and decode the first number of network coded packets. If sufficient time remains for transmission of a feedback value and receipt of a first retransmission, the retransmission logic circuitry of the one or more of the MLDs 1230, 1290, 1292, 1294, 1296, and 1298 may determine a feedback value based on receipt of the corresponding first number of network coded packets and cause transmission of the feedback value(s) to the retransmission logic circuitry of the AP MLD 1210.

After receipt of the feedback value(s) from the one or more of the MLDs 1230, 1290, 1292, 1294, 1296, and 1298, the AP MLD 1210 may determine the feedback values, identify corresponding sub-strategies of the one or more retransmission schemes, generate network coded packets for the first retransmission to each of the one or more of the MLDs 1230, 1290, 1292, 1294, 1296, and 1298, and cause transmission of a corresponding second number of network coded packets to each of the one or more of the MLDs 1230, 1290, 1292, 1294, 1296, and 1298. In many embodiments, this process of transmitting network coded packets and receiving feedback value(s) may continue until the feedback value(s) indicate that the one or more of the MLDs 1230, 1290, 1292, 1294, 1296, and 1298 have received the k network coded packets or there is insufficient time remaining of the time constraint (e.g., the TxOP) for transmission of the feedback value and/or subsequent receipt of a retransmission from the AP MLD 1210. For instance, if the MLD 1230 receives k network coded packets after the first transmission, the retransmission logic circuitry of the MLD 1230 may cause transmission of a feedback value that indicates the receipt of k network coded packets, which causes the retransmission logic circuitry of the AP MLD 1210 to terminate the retransmission scheme for the original set of k packets. If, however, retransmission logic circuitry of the MLD 1290 indicates causes transmission of a feedback value to the AP MLD 1210 that indicates a request to receive an additional number of network coded packets after the first retransmission, the retransmission logic circuitry of the AP MLD 1210 may select a corresponding sub-strategy for a second retransmission based on the feedback value received from the MLD 1290 and cause transmission of the number of network coded packets identified by the corresponding sub-strategy for a second retransmission to the MLD 1290.

In some embodiments, the retransmission logic circuitry of the AP MLD 1210 may cause transmission of the first transmission to the one or more of the MLDs 1230, 1290, 1292, 1294, 1296, and 1298 in a multi-user (MU) protocol data unit (MU-PPDU) on different channels of the same band. Similarly, the retransmission logic circuitry of the one or more of the MLDs 1230, 1290, 1292, 1294, 1296, and 1298 may cause transmissions of the feedback value(s) concurrently on different channels of the same band. For instance, the AP MLD 1210 and the one or more of the MLDs 1230, 1290, 1292, 1294, 1296, and 1298 may reside in the same facility. The AP MLD 1210 may receive one data stream to distribute to the each of the one or more of the MLDs 1230, 1290, 1292, 1294, 1296, and 1298 with the same time constraint, reliability, and spectral efficiency. Furthermore, the packet loss rates for each of the one or more of the MLDs 1230, 1290, 1292, 1294, 1296, and 1298 may be substantially similar (such as within a rounding error or plus or minus 1%, 5%, or 10%). In such situations, the retransmission logic circuitry of the AP MLD 1210 may determine the same full set of retransmission schemes, determine the same set of optimal retransmission schemes, and select the same retransmission scheme from the set of optimal retransmission schemes for each of the or more of the MLDs 1230, 1290, 1292, 1294, 1296, and 1298. In other embodiments, the retransmission logic circuitry of the AP MLD 1210 may determine based, e.g., an accuracy of the calculations related to determination of the failure probability and/or the packet loss probability, that the selection of the optimal retransmission scheme will be the same for each of the packet loss rates for the one or more of the MLDs 1230, 1290, 1292, 1294, 1296, and 1298.

In some embodiments, the retransmission logic circuitry of the AP MLD 1210 may cause transmission of at least the first transmission of network coded packets in an MU-PPDU to the one or more of the MLDs 1230, 1290, 1292, 1294, 1296, and 1298 when, for instance, the first transmissions to the one or more of the MLDs 1230, 1290, 1292, 1294, 1296, and 1298 include the same number of the same size network coded packets. Furthermore, the retransmission logic circuitry of the AP MLD 1210 may cause transmission of one or more of the retransmissions in an MU PPDU if such retransmissions include the same number of network coded packets for each of the one or more of the MLDs 1230, 1290, 1292, 1294, 1296, and 1298.

The AP MLD 1210 and MLD 1230 may comprise processor(s) 1201 and memory 1231, respectively. The processor(s) 1201 may comprise any data processing device such as a microprocessor, a microcontroller, a state machine, and/or the like, and may execute instructions or code in the memory 1211. The memory 1211 may comprise a storage medium such as Dynamic Random Access Memory (DRAM), read only memory (ROM), buffers, registers, cache, flash memory, hard disk drives, solid-state drives, or the like. The memory 1211 may store the frames, frame structures, frame headers, etc., 1212 and may also comprise code for retransmission logic circuitry and code to generate, scramble, encode, decode, parse, and interpret MAC frames and/or PHY frames and physical layer protocol data units (PPDUs).

The baseband processing circuitry 1218 may comprise a baseband processor and/or one or more circuits to implement an MLD station management entity (MM-SME) and a station management entity (SME) per link. The MM-SME may coordinate management of, communications between, and interactions between SMEs for the links.

In some embodiments, the SME may interact with a MAC layer management entity to perform MAC layer functionality and a PHY management entity to perform PHY functionality. In such embodiments, the baseband processing circuitry 1218 may interact with processor(s) 1201 to coordinate higher layer functionality with MAC layer and PHY functionality.

In some embodiments, the baseband processing circuitry 1218 may interact with one or more analog devices to perform PHY functionality such as scrambling, encoding, modulating, and the like. In other embodiments, the baseband processing circuitry 1218 may execute code to perform one or more of the PHY functionality such as scrambling, encoding, modulating, and the like.

The MAC layer functionality may execute MAC layer code stored in the memory 1211. In further embodiments, the MAC layer functionality may interface the processor(s) 1201.

The MAC layer functionality may communicate with the PHY via the SME to transmit a MAC frame such as an A-MPDU, in a PHY frame to the MLD 1230. The MAC layer functionality may generate frames such as management, data, and control frames.

The PHY may prepare the MAC frame for transmission by, e.g., determining a preamble to prepend to a MAC frame to create a PHY frame. The preamble may include one or more short training field (STF) values, long training field (LTF) values, and signal (SIG) field values. A wireless network interface 1222 or the baseband processing circuitry 1218 may prepare the PHY frame as a scrambled, encoded, modulated PPDU in the time domain signals for the radio 1224. Furthermore, the TSF timer 1205 may provide a timestamp value for inclusion in a timestamp field of the PPDU to indicate the time at which the PPDU is transmitted.

After processing the PHY frame, a radio 1225 may impress digital data onto subcarriers of RF frequencies for transmission by electromagnetic radiation via elements of an antenna array or antennas 1224 and via the network 1280 to a receiving MLD STA of a MLD such as the MLD 1230.

The wireless network I/F 1222 also comprises a receiver. The receiver receives electromagnetic energy, extracts the digital data, and the analog PHY and/or the baseband processor 1218 decodes a PHY frame and a MAC frame from a PPDU.

The MLD 1230 may receive a PPDU such as an A-MPDU from the AP MLD 1210 via the network 1280. The MLD 1230 may comprise processor(s) 1231 and memory 1241. The processor(s) 1231 may comprise any data processing device such as a microprocessor, a microcontroller, a state machine, and/or the like, and may execute instructions or code in the memory 1241. The memory 1241 may comprise a storage medium such as Dynamic Random Access Memory (DRAM), read only memory (ROM), buffers, registers, cache, flash memory, hard disk drives, solid-state drives, or the like. The memory 1241 may store 1242 the frames, frame structures, frame headers, etc., and may also comprise code for retransmission logic circuitry and code to generate, scramble, encode, decode, parse, and interpret MAC frames and/or PHY frames (PPDUs).

The baseband processing circuitry 1248 may comprise a baseband processor and/or one or more circuits to implement a SME and the SME may interact with a MAC layer management entity to perform MAC layer functionality and a PHY management entity to perform PHY functionality. In such embodiments, the baseband processing circuitry 1248 may interact with processor(s) 1231 to coordinate higher layer functionality with MAC layer and PHY functionality.

In some embodiments, the baseband processing circuitry 1218 may interact with one or more analog devices to perform PHY functionality such as descrambling, decoding, demodulating, and the like. In other embodiments, the baseband processing circuitry 1218 may execute code to perform one or more of the PHY functionalities such as descrambling, decoding, demodulating, and the like.

The MLD 1230 may receive the PPDU at the antennas 1258, which pass the signals along to the FEM 1256. The FEM 1256 may amplify and filter the signals and pass the signals to the radio 1254 (also referred to as RF circuitry or radio integrated circuit (IC) circuitry). The radio 1254 may filter the carrier signals from the signals and determine if the signals represent a PPDU. If so, analog circuitry of the wireless network I/F 1252 or physical layer functionality implemented in the baseband processing circuitry 1248 may demodulate, decode, descramble, etc. the PPDU. The baseband processing circuitry 1248 may identify, parse, and interpret a MAC service data unit (MSDU) from the physical layer service data unit (PSDU) of the PPDU.

FIG. 1D is a block diagram of a radio architecture 1300 such as the wireless communications I/F 1222 and 1252 in accordance with some embodiments that may be implemented in, e.g., the AP MLD 1210 and/or the MLD 1230 of FIG. 1C. The radio architecture 1300 may include radio front-end module (FEM) circuitry 1304a-b, radio IC circuitry 1306a-b and baseband processing circuitry 1308a-b. The radio architecture 1300 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1304a-b may include a WLAN or Wi-Fi FEM circuitry 1304a and a Bluetooth (BT) FEM circuitry 1304b. The WLAN FEM circuitry 1304a may include a receive signal path comprising circuitry configured to operate on WLAN RF signals received from one or more antennas 1301, to amplify the received signals and to provide the amplified versions of the received signals to the WLAN radio IC circuitry 1306a for further processing. The BT FEM circuitry 1304b may include a receive signal path which may include circuitry configured to operate on BT RF signals received from one or more antennas 1301, to amplify the received signals and to provide the amplified versions of the received signals to the BT radio IC circuitry 1306b for further processing. FEM circuitry 1304a may also include a transmit signal path which may include circuitry configured to amplify WLAN signals provided by the radio IC circuitry 1306a for wireless transmission by one or more of the antennas 1301. In addition, FEM circuitry 1304b may also include a transmit signal path which may include circuitry configured to amplify BT signals provided by the radio IC circuitry 1306b for wireless transmission by the one or more antennas. In the embodiment of FIG. 1D, although FEM 1304a and FEM 1304b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1306a-b as shown may include WLAN radio IC circuitry 1306a and BT radio IC circuitry 1306b. The WLAN radio IC circuitry 1306a may include a receive signal path which may include circuitry to down-convert WLAN RF signals received from the FEM circuitry 1304a and provide baseband signals to WLAN baseband processing circuitry 1308a. BT radio IC circuitry 1306b may in turn include a receive signal path which may include circuitry to down-convert BT RF signals received from the FEM circuitry 1304b and provide baseband signals to BT baseband processing circuitry 1308b. WLAN radio IC circuitry 1306a may also include a transmit signal path which may include circuitry to up-convert WLAN baseband signals provided by the WLAN baseband processing circuitry 1308a and provide WLAN RF output signals to the FEM circuitry 1304a for subsequent wireless transmission by the one or more antennas 1301. BT radio IC circuitry 1306b may also include a transmit signal path which may include circuitry to up-convert BT baseband signals provided by the BT baseband processing circuitry 1308b and provide BT RF output signals to the FEM circuitry 1304b for subsequent wireless transmission by the one or more antennas 1301. In the embodiment of FIG. 1D, although radio IC circuitries 1306a and 1306b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1308a-b may include a WLAN baseband processing circuitry 1308a and a BT baseband processing circuitry 1308b. The WLAN baseband processing circuitry 1308a may include a memory, such as, for example, a set of RAM arrays in a Fast Fourier Transform or Inverse Fast Fourier Transform block (not shown) of the WLAN baseband processing circuitry 1308a. Each of the WLAN baseband circuitry 1308a and the BT baseband circuitry 1308b may further include one or more processors and control logic to process the signals received from the corresponding WLAN or BT receive signal path of the radio IC circuitry 1306a-b, and to also generate corresponding WLAN or BT baseband signals for the transmit signal path of the radio IC circuitry 1306a-b. Each of the baseband processing circuitries 1308a and 1308b may further include physical layer (PHY) and medium access control layer (MAC) circuitry, and may further interface with a device for generation and processing of the baseband signals and for controlling operations of the radio IC circuitry 1306a-b.

Referring still to FIG. 1D, according to the shown embodiment, WLAN-BT coexistence circuitry 1313 may include logic providing an interface between the WLAN baseband circuitry 1308a and the BT baseband circuitry 1308b to enable use cases requiring WLAN and BT coexistence. In addition, a switch circuitry 1303 may be provided between the WLAN FEM circuitry 1304a and the BT FEM circuitry 1304b to allow switching between the WLAN and BT radios according to application needs. In addition, although the antennas 1301 are depicted as being respectively connected to the WLAN FEM circuitry 1304a and the BT FEM circuitry 1304b, embodiments include within their scope the sharing of one or more antennas as between the WLAN and BT FEMs, or the provision of more than one antenna connected to each of FEM 1304a or 1304b.

In some embodiments, the front-end module circuitry 1304a-b, the radio IC circuitry 1306a-b, and baseband processing circuitry 1308a-b may be provided on a single radio card, such as wireless network interface card (NIC) 1302. In some other embodiments, the one or more antennas 1301, the FEM circuitry 1304a-b and the radio IC circuitry 1306a-b may be provided on a single radio card. In some other embodiments, the radio IC circuitry 1306a-b and the baseband processing circuitry 1308a-b may be provided on a single chip or integrated circuit (IC), such as IC 1312.

In some embodiments, the wireless NIC 1302 may include a WLAN radio card and may be configured for Wi-Fi communications, although the scope of the embodiments is not limited in this respect. In some of these embodiments, the radio architecture 1300 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 1300 may be part of a Wi-Fi communication station (STA) such as a wireless access point (AP), a base station or a mobile device including a Wi-Fi device. In some of these embodiments, radio architecture 1300 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2020, IEEE 802.11ay-2021, IEE 802.11ba-2021, IEEE 802.11ax-2021, and/or IEEE 802.11be standards and/or proposed specifications for WLANs, although the scope of embodiments is not limited in this respect. The radio architecture 1300 may also be suitable to transmit and/or receive communications in accordance with other techniques and standards.

In some embodiments, the radio architecture 1300 may be configured for high-efficiency Wi-Fi (HEW) communications in accordance with the IEEE 802.11ax-2021 standard. In these embodiments, the radio architecture 1300 may be configured to communicate in accordance with an OFDMA technique, although the scope of the embodiments is not limited in this respect.

In some other embodiments, the radio architecture 1300 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1D, the BT baseband circuitry 1308b may be compliant with a Bluetooth (BT) connectivity specification such as Bluetooth 5.0, or any other iteration of the Bluetooth specification.

In some embodiments, the radio architecture 1300 may include other radio cards, such as a cellular radio card configured for cellular (e.g., 5GPP such as LTE, LTE-Advanced or 7G communications).

In some IEEE 802.11 embodiments, the radio architecture 1300 may be configured for communication over various channel bandwidths including bandwidths having center frequencies of about 2.4 GHz, 5 GHz, and 6 GHz. The various bandwidths may include bandwidths of about 20 MHz, 40 MHz, 80 MHz, 160 MHz, 240 MHz, and 320 MHz with contiguous or non-contiguous bandwidths having increments of 20 MHz, 40 MHz, 80 MHz, 160 MHz, 240 MHz, and 320 MHz. The scope of the embodiments is not limited with respect to the above center frequencies, however.

FIG. 1E illustrates FEM circuitry 1400 such as WLAN FEM circuitry 1304a shown in FIG. 1 D in accordance with some embodiments. Although the example of FIG. 1E is described in conjunction with the WLAN FEM circuitry 1304a, the example of FIG. 1E may be described in conjunction with other configurations such as the BT FEM circuitry 1304b.

In some embodiments, the FEM circuitry 1400 may include a TX/RX switch 1402 to switch between transmit mode and receive mode operation. The FEM circuitry 1400 may include a receive signal path and a transmit signal path. The receive signal path of the FEM circuitry 1400 may include a low-noise amplifier (LNA) 1406 to amplify received RF signals 1403 and provide the amplified received RF signals 1407 as an output (e.g., to the radio IC circuitry 1306a-b (FIG. 1D)). The transmit signal path of the circuitry 1304a may include a power amplifier (PA) to amplify input RF signals 1409 (e.g., provided by the radio IC circuitry 1306a-b), and one or more filters 1412, such as band-pass filters (BPFs), low-pass filters (LPFs) or other types of filters, to generate RF signals 1415 for subsequent transmission (e.g., by one or more of the antennas 1301 (FIG. 1D)) via an example duplexer 1414.

In some dual-mode embodiments for Wi-Fi communication, the FEM circuitry 1400 may be configured to operate in the 2.4 GHz frequency spectrum, the 5 GHz frequency spectrum, or the 6 GHz frequency spectrum. In these embodiments, the receive signal path of the FEM circuitry 1400 may include a receive signal path duplexer 1404 to separate the signals from each spectrum as well as provide a separate LNA 1406 for each spectrum as shown. In these embodiments, the transmit signal path of the FEM circuitry 1400 may also include a power amplifier 1410 and a filter 1412, such as a BPF, an LPF or another type of filter for each frequency spectrum and a transmit signal path duplexer 1404 to provide the signals of one of the different spectrums onto a single transmit path for subsequent transmission by the one or more of the antennas 1301 (FIG. 1D). In some embodiments, BT communications may utilize the 2.4 GHz signal paths and may utilize the same FEM circuitry 1400 as the one used for WLAN communications.

FIG. 1F illustrates radio IC circuitry 1506a in accordance with some embodiments. The radio IC circuitry 1306a is one example of circuitry that may be suitable for use as the WLAN or BT radio IC circuitry 1306a/1306b (FIG. 1D), although other circuitry configurations may also be suitable. Alternatively, the example of FIG. 1F may be described in conjunction with the example BT radio IC circuitry 1306b.

In some embodiments, the radio IC circuitry 1306a may include a receive signal path and a transmit signal path. The receive signal path of the radio IC circuitry 1306a may include at least mixer circuitry 1502, such as, for example, down-conversion mixer circuitry, amplifier circuitry 1506 and filter circuitry 1508. The transmit signal path of the radio IC circuitry 1306a may include at least filter circuitry 1512 and mixer circuitry 1514, such as, for example, upconversion mixer circuitry. Radio IC circuitry 1306a may also include synthesizer circuitry 1504 for synthesizing a frequency 1505 for use by the mixer circuitry 1502 and the mixer circuitry 1514. The mixer circuitry 1502 and/or 1514 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 1F illustrates only a simplified version of a radio IC circuitry, and may include, although not shown, embodiments where each of the depicted circuitries may include more than one component. For instance, mixer circuitry 1514 may each include one or more mixers, and filter circuitries 1508 and/or 1512 may each include one or more filters, such as one or more BPFs and/or LPFs according to application needs. For example, when mixer circuitries are of the direct-conversion type, they may each include two or more mixers.

In some embodiments, mixer circuitry 1502 may be configured to down-convert RF signals 1407 received from the FEM circuitry 1304a-b (FIG. 1D) based on the synthesized frequency 1505 provided by synthesizer circuitry 1504. The amplifier circuitry 1506 may be configured to amplify the down-converted signals and the filter circuitry 1508 may include an LPF configured to remove unwanted signals from the down-converted signals to generate output baseband signals 1507. Output baseband signals 1507 may be provided to the baseband processing circuitry 1308a-b (FIG. 1D) for further processing. In some embodiments, the output baseband signals 1507 may be zero-frequency baseband signals, although this is not a requirement. In some embodiments, mixer circuitry 1502 may comprise passive mixers, although the scope of the embodiments is not limited in this respect.

In some embodiments, the mixer circuitry 1514 may be configured to up-convert input baseband signals 1511 based on the synthesized frequency 1505 provided by the synthesizer circuitry 1504 to generate RF output signals 1409 for the FEM circuitry 1304a-b. The baseband signals 1511 may be provided by the baseband processing circuitry 1308a-b and may be filtered by filter circuitry 1512. The filter circuitry 1512 may include an LPF or a BPF, although the scope of the embodiments is not limited in this respect.

In some embodiments, the mixer circuitry 1502 and the mixer circuitry 1514 may each include two or more mixers and may be arranged for quadrature down-conversion and/or upconversion respectively with the help of synthesizer 1504. In some embodiments, the mixer circuitry 1502 and the mixer circuitry 1514 may each include two or more mixers each configured for image rejection (e.g., Hartley image rejection). In some embodiments, the mixer circuitry 1502 and the mixer circuitry 1514 may be arranged for direct down-conversion and/or direct upconversion, respectively. In some embodiments, the mixer circuitry 1502 and the mixer circuitry 1514 may be configured for super-heterodyne operation, although this is not a requirement.

Mixer circuitry 1502 may comprise, according to one embodiment: quadrature passive mixers (e.g., for the in-phase (I) and quadrature phase (Q) paths). In such an embodiment, RF input signal 1407 from FIG. 1F may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1505 of synthesizer 1504 (FIG. 1F). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1407 (FIG. 1E) may comprise a balanced signal, although the scope of the embodiments is not limited in this respect. The I and Q baseband output signals may be provided to low-noise amplifier, such as amplifier circuitry 1506 (FIG. 1F) or to filter circuitry 1508 (FIG. 1F).

In some embodiments, the output baseband signals 1507 and the input baseband signals 1511 may be analog baseband signals, although the scope of the embodiments is not limited in this respect. In some alternate embodiments, the output baseband signals 1507 and the input baseband signals 1511 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1504 may be a fractional-N synthesizer or a fractional N/N+1 synthesizer, although the scope of the embodiments is not limited in this respect as other types of frequency synthesizers may be suitable. For example, synthesizer circuitry 1504 may be a delta-sigma synthesizer, a frequency multiplier, or a synthesizer comprising a phase-locked loop with a frequency divider. According to some embodiments, the synthesizer circuitry 1504 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1504 may be provided by a voltage-controlled oscillator (VCO), although that is not a requirement. A divider control input may further be provided by either of the baseband processing circuitry 1308a-b (FIG. 1D) depending on the desired output frequency 1505. In some embodiments, a divider control input (e.g., N) may be determined from a look-up table (e.g., within a Wi-Fi card) based on a channel number and a channel center frequency as determined or indicated by the example application processor 1310. The application processor 1310 may include, or otherwise be connected to, one of the example secure signal converter 101 or the example received signal converter 103 (e.g., depending on which device the example radio architecture is implemented in).

In some embodiments, synthesizer circuitry 1504 may be configured to generate a carrier frequency as the output frequency 1505, while in other embodiments, the output frequency 1505 may be a fraction of the carrier frequency (e.g., one-half the carrier frequency, one-third the carrier frequency). In some embodiments, the output frequency 1505 may be a LO frequency (fLO).

FIG. 1G illustrates a functional block diagram of baseband processing circuitry 1308a in accordance with some embodiments. The baseband processing circuitry 1308a is one example of circuitry that may be suitable for use as the baseband processing circuitry 1308a (FIG. 1D), although other circuitry configurations may also be suitable. Alternatively, the example of FIG. 1F may be used to implement the example BT baseband processing circuitry 1308b of FIG. 1D.

The baseband processing circuitry 1308a may include a receive baseband processor (RX BBP) 1602 for processing receive baseband signals 1509 provided by the radio IC circuitry 1306a-b (FIG. 1D) and a transmit baseband processor (TX BBP) 1604 for generating transmit baseband signals 1511 for the radio IC circuitry 1306a-b. The baseband processing circuitry 1308a may also include control logic 1606 for coordinating the operations of the baseband processing circuitry 1308a.

In some embodiments (e.g., when analog baseband signals are exchanged between the baseband processing circuitry 1308a-b and the radio IC circuitry 1306a-b), the baseband processing circuitry 1308a may include ADC 1610 to convert analog baseband signals 1609 received from the radio IC circuitry 1306a-b to digital baseband signals for processing by the RX BBP 1602. In these embodiments, the baseband processing circuitry 1308a may also include DAC 1612 to convert digital baseband signals from the TX BBP 1604 to analog baseband signals 1611.

In some embodiments that communicate OFDM signals or OFDMA signals, such as through baseband processor 1308a, the transmit baseband processor 1604 may be configured to generate OFDM or OFDMA signals as appropriate for transmission by performing an inverse fast Fourier transform (IFFT). The receive baseband processor 1602 may be configured to process received OFDM signals or OFDMA signals by performing an FFT. In some embodiments, the receive baseband processor 1602 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1D, in some embodiments, the antennas 1301 (FIG. 1D) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1301 may each include a set of phased-array antennas, although embodiments are not so limited.

Although the radio architecture 1300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 6^{th} generation mobile networks, 3GPP, long term evolution (LTE), LTE advanced, enhanced data rates for GSM Evolution (EDGE), or the like. Other embodiments may be used in various other devices, systems, and/or networks.

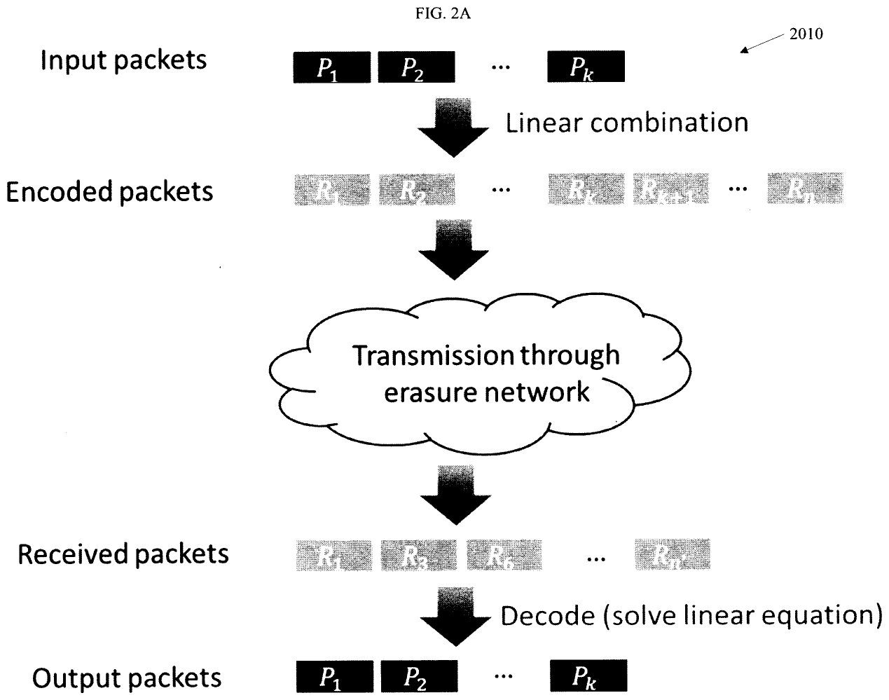

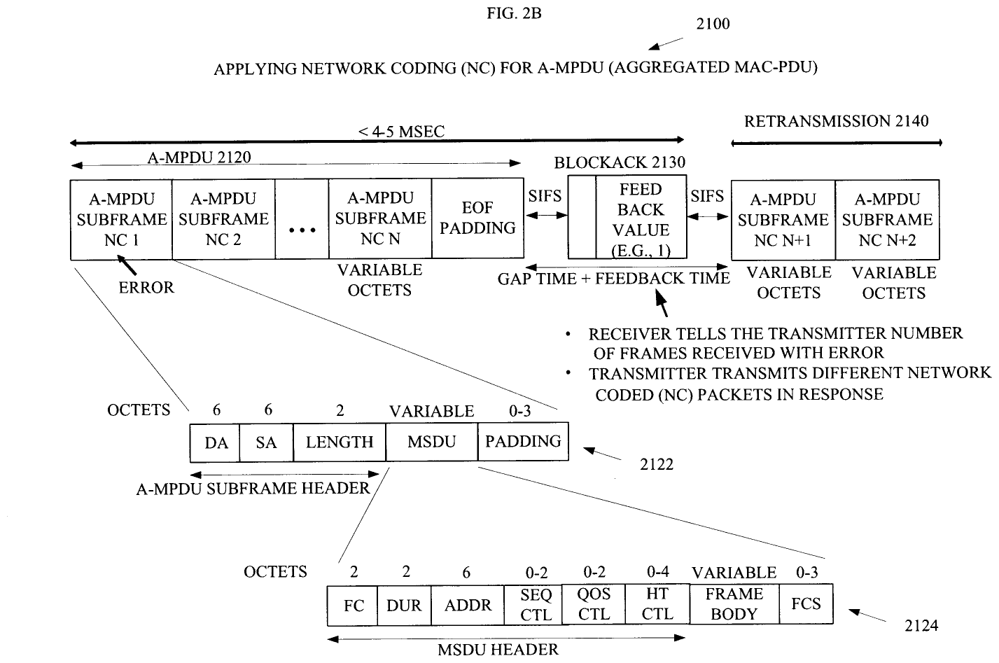

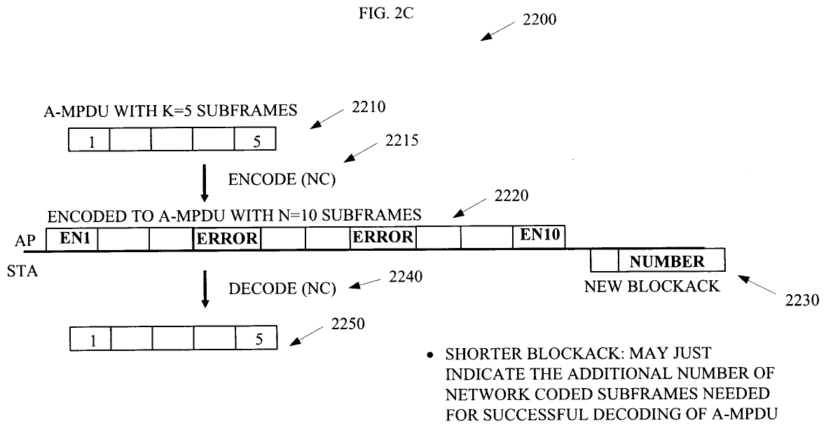

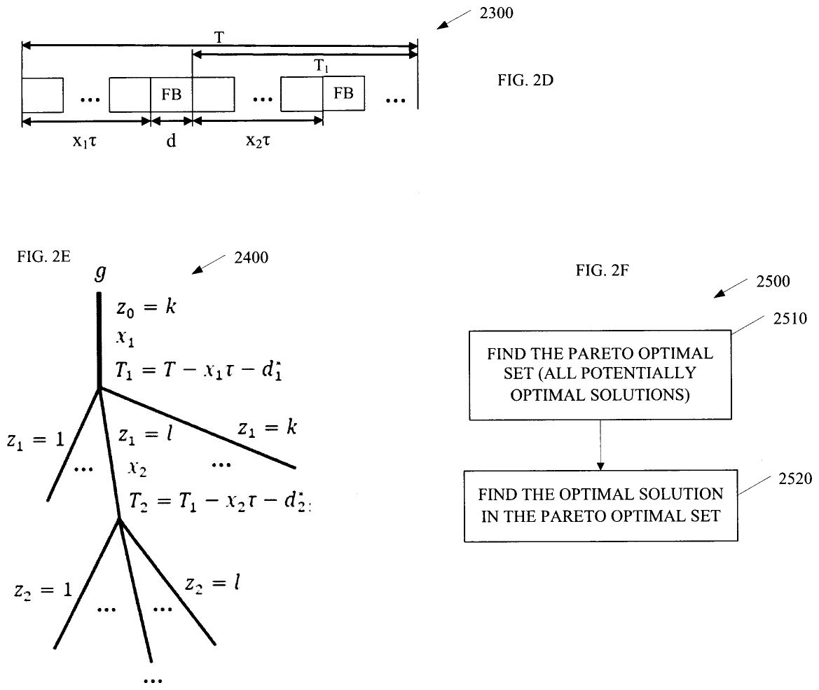

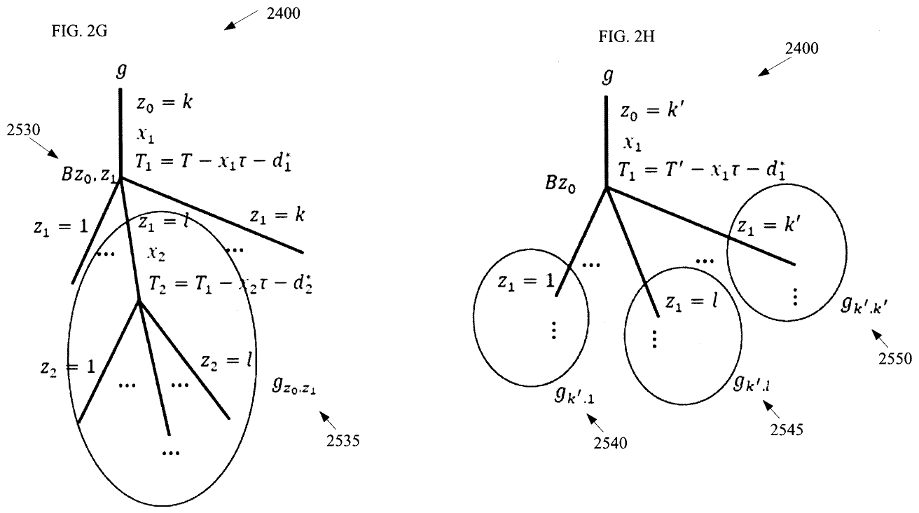

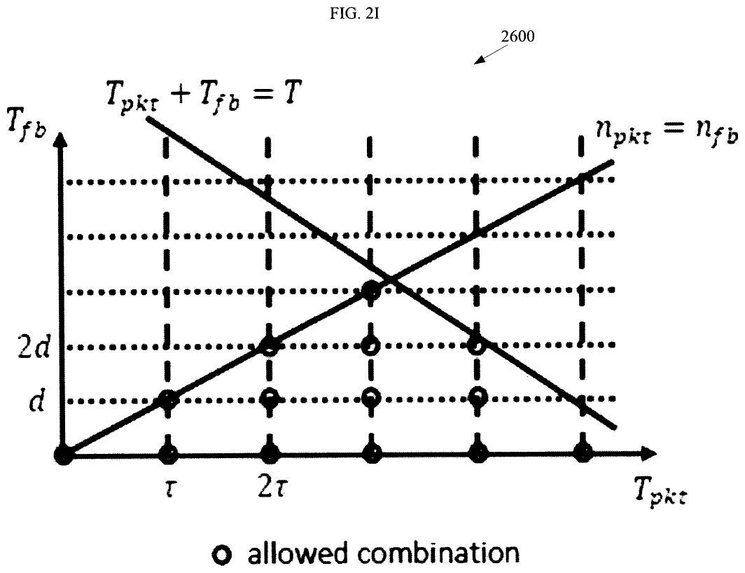

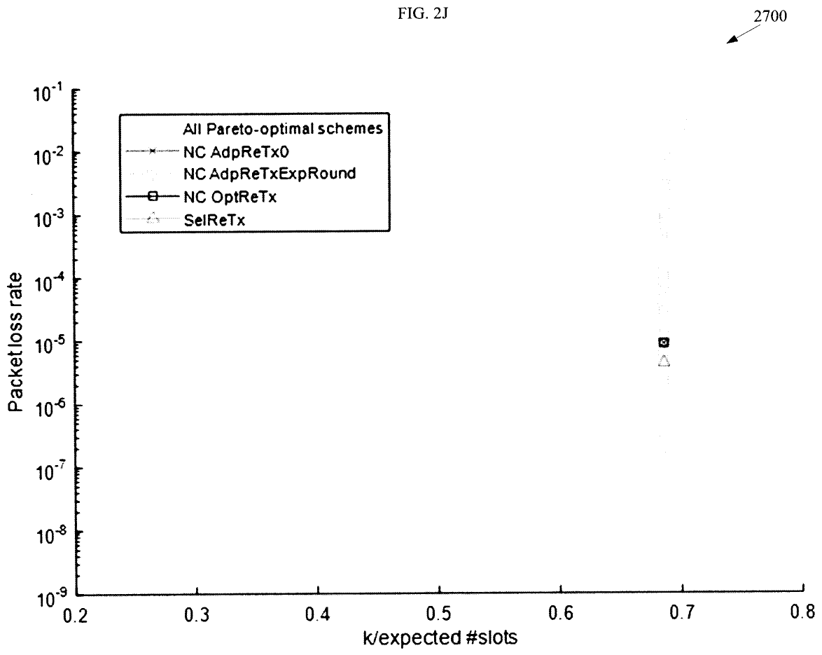

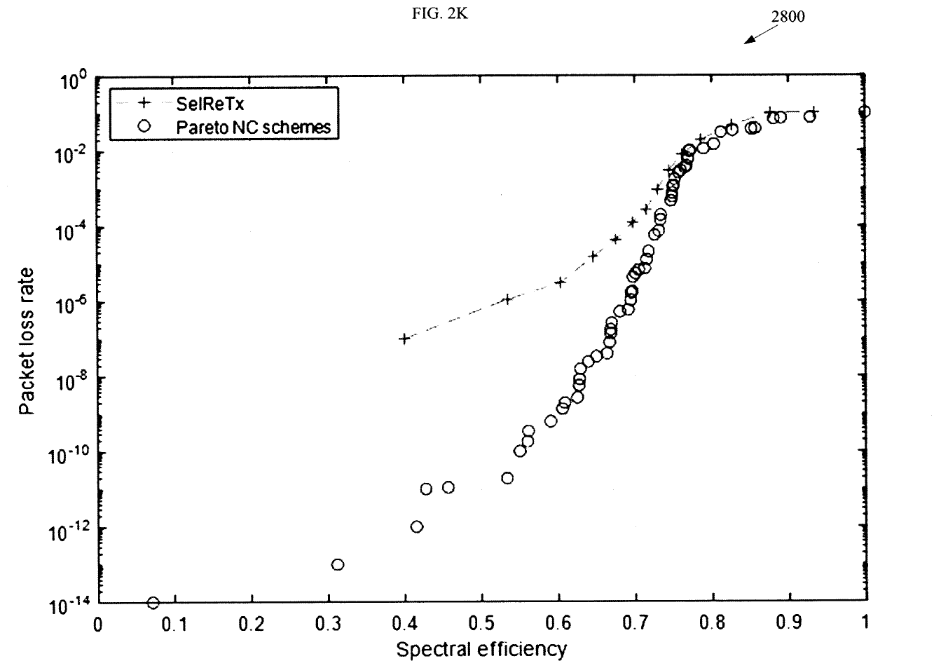

FIG. 2A illustrates an embodiment 2010 of network coding of an original set of k data packets [P₁, P₂, . . . , Pₖ] by retransmission logic circuitry of a STA such as the MLDs illustrated and discussed in conjunction with FIGS. 1A-1G. Given a set of k same-sized packets [P₁, P₂, . . . , Pₖ] viewed as column vectors over a Galois Field [symbol] , the retransmission logic circuitry may construct or generate a linearly coded packet as R=Σᵢ₌₁^{k}cᵢ·Pᵢ, where the encoding vector [c₁, c₂, . . . , cₖ]^{T} comprises coefficients chosen from the Galois Field [symbol] . Concurrently or after generation of the linearly coded packets, the retransmission logic circuitry may cause transmission of multiple of such linearly coded packets with different encoding vectors through a lossy channel/network to retransmission logic circuitry of a second STA, where packets may be dropped (erasure) based on errors in receipt of the linearly coded packets. If the retransmission logic circuitry of the second STA receives k of the network coded packets [R₁, R₂, . . . , Rₖ] that are linearly independent, then the retransmission logic circuitry of the second STA can recover the original packets [P₁, P₂, . . . , Pₖ] using [R₁ R₂ . . . Rₖ]M⁻¹, where

$$\\ M = [ \begin{matrix}{c}_{1}^{1} & {c}_{1}^{2} & ⋯ & {c}_{1}^{k} \\ {c}_{2}^{1} & {c}_{2}^{2} & ⋯ & {c}_{2}^{k} \\ ⋮ & ⋮ & ⋯ & ⋮ \\ {c}_{k}^{1} & {c}_{k}^{2} & ⋯ & {c}_{k}^{k}\end{matrix} ] ,$$

the i-th column of which consists of the encoding vector for Rᵢ.

Network coding provides much better Rate-Reliability trade-off than repetition, and this trade-off improves with increasing coding group size (k). In practice, the coding coefficients are often chosen from codes with good performances, e.g., with maximum distance separable (MDS) property, such that any choices of k encoding vectors are linearly independent.

FIG. 2B illustrates an embodiment 2100 of an aggregated MAC PDU (A-MPDU) frame structure 2120 and communications exchanged between retransmission logic circuitry of STAs. The retransmission logic circuitry of a transmitter STA may transmit the A-MPDU 2120 as a single PPDU and each A-MPDU frame 2120 comprises multiple A-MPDU subframes. Each of the subframes, in the present embodiment, includes a network coded packet numbered NC 1 through NC N+2. The network coded data of the network coded packet resides in the frame body of the MSDU 2124 of each A-MPDU subframe 2122.

The A-MPDU subframe 2122 may be an example of fields that may reside in each of the A-MPDU subframes in the A-MPDU 2120 although embodiments are not limited to the fields in this embodiment of the A-MPDU subframe 2122. The A-MPDU subframe 2122 may comprise a destination address (DA) field, a source address (SA) field, a length field, a MSDU field, and optionally padding. The DA field may comprise an address such as a MAC address of the receiver STA. The SA may comprise an address such as a MAC address of the transmitter STA. The length may comprise the length in octets of the MSDU. And the padding may reside in each A-MPDU to increase the size A-MPDU subframe length to a multiple of four octets except that the last A-MPDU may not include padding.

In the present embodiment, the MSDU 2124 may comprise a MSDU header, a frame body, and a frame check sequence. The MSDU header may comprise a frame control (FC) field, a duration field, an optional sequence control field, an optional quality of service (QoS) field, and an optional high-throughput (HT) control field. The FC field may comprise a frame type field, a frame subtype field, and possibly other fields. The duration field may comprise a network allocation vector to indicate the time remaining in the transmission such as the time remaining in the time constraint (T).

The optional sequence control field may comprise a fragment number field and a sequence number field. The fragment number field may comprise a fragment number such as zero and the sequence field may comprise a sequence number associated with a sequence number assigned to the original set of k packets of data of the data stream included in the network coded packets.

The QoS field may be present in a QoS data frame and may include two bits comprising an Ack policy indicator, four bits comprising a traffic identifier, eight bits comprising a TxOP limit, and possibly other bits. The Ack policy indicator may indicate the block acknowledgement policy for the A-MPDU 2120. The traffic identifier (TID) may, in some embodiments, identify the data in the network coded packets as part of a data stream. The TxOP limit may, in some embodiments, specify a time limit on a TxOP for the retransmission scheme for the A-MPDU 2120.

After the transmission of the A-MPDU 2120 to the receiver STA, the retransmission logic circuitry of the receiver STA may decode the A-MPDU 2120 to determine a feedback value indicative of the number of network coded packets received or indicative of the number of network coded packets that the receiver STA still needs to receive to decode the entire set of the original k data packets from the data stream. The retransmission logic circuitry of the receiver STA may cause transmission of a BlockAck 2130 including the feedback value such as one. If the feedback value indicates that zero more network coded packets are requested, the receiver STA has received k network coded packets from the transmitter STA and the retransmission scheme terminates. In the present embodiment, the feedback value of one indicates that a retransmission 2140, in accordance with the retransmission scheme, is requested.

In the present embodiment, the BlockAck 2130 may be a new BlockAck frame format that replaces a bitmap fields indicative of each subframe in A-MPDU in current BlockAcks with a collective number (which may indicate the additional number of encoded packets the receiver wants), thus having a shorter field size than the bitmap fields. In present embodiment, we assume the number of additional packets needed for decoding is reported in the BlockAck 2130. For example, if k is the number of packets encoded together, then, as mentioned above, the receiver needs to gather at least k encoded packets to enable decoding. If after the last round of (re)transmission, k′<k packets are received and so k-k′ more packets are needed for decoding, then the number k-k′ is fed back in the BlockAck 2130.

Note that embodiments are not limited to use of the new BlockAck format. The current BlockAck format may be used to communicate the feedback value by indicating the feedback value in the bitmaps. However, since the retransmission schemes may not need to the additional information about which of the specific packets were erased or dropped, the retransmission logic circuitry of the receiver of the transmitter STA may interpret the bitmaps to represent the feedback value.

The BlockAck 2130 is separated from the A-MPDU 2120 by an interframe space such as a short interframe space (SIFS). The BlockAck 2130 is separated from the retransmission 2140 by the transmitter STA (another A-MPDU with additional network coded packets NC N+1 and NC N+2) by an interframe space such a SIFS to allow the transmitter STA and the receiver STA to transition between transmitting and receiving (Tx/Rx transition). The combination of the SIFS between the A-MPDU 2120 and the BlockAck 2130 and the SIFS between the BlockAck 2130 and the retransmission 2140 may represent the gap time for calculations used by the retransmission logic circuitry of the transmitter STA to determine the retransmission scheme. Note also that the value of d in the calculations described herein includes the sum of the feedback time (time for transmission of the feedback such as a BlockAck) and the gap time.

FIG. 2C illustrates an embodiment 2200 of an example of a packet flow for a retransmission scheme. At 2210, the retransmission logic circuitry of an AP STA may receive an A-MPDU with an original set of k (five) packets 2250. In preparation for transmitting the original set of k packets to a STA, the retransmission logic circuitry of the AP STA may encode 2215 the five data packets with network coding at a code rate of k/n, which is 5/10 in the present embodiment, to have a sufficient number of network coded packets for a retransmission scheme.

The retransmission logic circuitry of the AP STA may include the ten network coded packets in a payload or frame body of an MSDU of ten A-MPDU subframes of the A-MPDU 2220 and may cause transmission of the A-MPDU 2220 to the STA. The retransmission logic circuitry of the STA may receive the A-MPDU 2220 and begin to decode 2240 the A-MPDU 2220 to determine the original set of k (five) packets 2250.

Before, during, or after decoding 2240 the original set of k (five) packets 2250, the retransmission logic circuitry of the STA may determine that two of the ten A-MPDU subframes of the A-MPDU 2220 were dropped due to errors in reception of the two of the ten A-MPDU subframes. Based on receipt of eight of the ten A-MPDU subframes and the linear independency of any subset of five (k) of the ten network coded packets in the A-MPDU subframes, however, the retransmission logic circuitry of the STA may decode 2240 the A-MPDU 2220 to determine the original set of k (five) packets 2250.

Before, during, or after decoding 2240 the original set of k (five) packets 2250, the retransmission logic circuitry of the STA may generate and cause transmission of a BlockAck with the value of zero to indicate that the STA requests no more network coded packets, with a value of eight to indicate that the STA received eight of the network coded packets, or with the value of five to indicate that the retransmission logic circuitry of the STA successfully decoded five of the original set of k (five) packets 2250. In response to receipt of the BlockAck, the retransmission logic circuitry of the AP STA may terminate the retransmission scheme for the original set of k (five) packets 2250.

FIG. 2D illustrates an embodiment of a network coding retransmission scheme 2300 such as the retransmission scheme discussed in FIGS. 1A-1G and 2A-2C. In the first transmission of the retransmission scheme, the retransmission logic circuitry of an AP STA may cause transmission of x₁ encoded packets in an A-MPDU to a STA and each packet takes time T to transmit. Due to random errors, some packets may be dropped and y₁ of them are received by the retransmission logic circuitry of the STA, where y₁≤x₁. Thus, the retransmission logic circuitry of the STA to receive z₁=max(k−y₁, 0) more packets to be able to decode the original set of k packets. The retransmission logic circuitry of the STA may send feedback comprising or indicating the number z₁ in the BlockAck, if there is enough time to do so. If the retransmission logic circuitry of the STA causes transmission of a feedback value, then an extra time d is needed, which accounts for both the feedback time and gap time. As a result, after the first transmission of the retransmission scheme, the remaining available time is

T₁=T−x₁τ−d₁*,

where dᵢ*=d if there is a feedback value transmitted, otherwise d₁*=0. If the remaining time T₁ allows for further transmissions and the retransmission logic circuitry of the AP STA chooses to do so in accordance with the retransmission scheme with a strategy g, then the retransmission logic circuitry of the AP STA may cause transmission of a second A-MPDU. The second A-MPDU may contain x₂ packets and the transmission time may be x₂τ. This retransmission process continues until the retransmission logic circuitry of the STA acknowledges in the BlockAck that 0 more packets are needed, which may indicate that decoding is successful, or until the time T is used up, or the transmitter decides to stop any further transmissions, whichever occurs earlier.

We assume that each packet is dropped with an independent and identically distributed probability eᵣ. In this case, a general network coding retransmission scheme is a strategy g that may determine how many encoded packets xᵢ to transmit for each round i, given the remaining time Tᵢ and the number of missing packets zᵢ₋₁ at the retransmission logic circuitry of the STA to enable decoding. An embodiment of such a retransmission scheme 2400 is illustrated in FIG. 2E.

In FIG. 2E, for example, after the first transmission, z₁=l packets are still missing at the retransmission logic circuitry of the STA so the retransmission logic circuitry of the STA causes transmission of a feedback value such as one and the retransmission strategy g determines that the number of packets (x₂) to transmit in the next round (the first retransmission). If z₁ takes a different value, then x₂ may be a different number. It is convenient to represent each strategy as a tree (of finite depth as the time T is finite), where each layer represents a round of transmission and each branch in a layer i corresponds to a different value of zᵢ₋₁.

If we do not have the time limit or constraint T then the channel becomes stationary and, for each round of retransmission, the retransmission logic circuitry of the AP STA only needs to consider a time-invariant strategy g that depends solely on the number of missing packets zᵢ fed back in the BlockAck. In other words, the tree of the retransmission scheme 2400 reduces to its 2nd layer, as other layers are its repetitions. For this case (no time limit), many embodiments may find the optimal network coding retransmission scheme to minimize expected resource usage when packets are required to be delivered successfully (i.e., absolutely reliable).

When a time constraint T is imposed, however, the retransmission scheme for no time limit may not be optimal. Furthermore, there might be different combinations/balances in the performances of reliability and spectral efficiency in different scenarios. Optimizing for a given performance measure combination is difficult when there is a time constraint, as it often requires exhaustive searching of all the trees in the form of the retransmission strategy g of retransmission scheme 2400 which is a large number with respect to the time-unlimited case where the tree reduces to a single layer.

FIG. 2F illustrates an embodiment of a two-step optimization approach 2500 and recursions for the performance metrics for determining a Pareto optimal set of retransmission schemes such as the retransmission schemes discussed in FIGS. 1A-1G and 2A-2E. Despite the difficulty for solving the optimization problem directly as discussed in conjunction with FIG. 2E, targeting a particular performance measure combination may greatly simplify the optimization if we decompose the optimization process into the two-step optimization approach 2500.

First, at element 2510, the retransmission logic circuitry of the AP STA may find the candidate set of all schemes, P(k′,T), that are potentially optimal for some balance point of performances such as a Pareto-optimal set for reliability and spectral efficiency. Based on the structure of the recursive expressions of the performance metrics, the retransmission logic circuitry of the AP STA may perform Pareto optimization recursively, greatly improving the search efficiency, as in each recursion, any retransmission sub-schemes (or retransmission sub-strategies) that lead to non-Pareto optimal full retransmission schemes are efficiently pruned by the retransmission logic circuitry of the AP STA. Note that any STA may perform the two-step optimization approach 2500 even though many embodiments herein describe actions of an AP STA performing the two-step optimization approach 2500.

After the Pareto optimal set, P(k′,T), is found, the retransmission logic circuitry of the AP STA may search the candidate set of all potentially optimal schemes, P(k′,T), for an optimal solution for a particular combination of performance metrics, which is significantly smaller and finding the optimal scheme is usually much easier.

FIG. 2G illustrates an embodiment of a two-step optimization approach 2400 from FIG. 2E with the branch B_{z}_{₀}_{,z}_{₁} 2530 and the sub-strategies g_{z}_{₀}_{,z}_{₁} 2535 identified. The tuple (z₀, . . . , zᵢ₋₁) may identify a particular path up to the i-th round of transmission, which corresponds to a branch B_{z}_{₀}_{, . . . , z}_{_{i−1}} on a strategy tree g. For example, the branch B_{z}_{₀}_{,z}_{₁} 2530 denotes the 2-round transmission path with z₀=k, z₁=1. For each branch B_{z}_{₀}_{, . . . , z}_{_{i−1}}, the retransmission logic circuitry of a STA may define the function value of the strategy g on this branch as g(B_{z}_{₀}_{, . . . , z}_{_{i−1}})=xᵢ, which is the number of transmitted packets in the i-th round if the path (z₀, . . . , zᵢ₋₁) occurs.

The sub-strategy corresponding to the subtree stemming from the end section of the branch B_{z}_{₀}_{, . . . , z}_{_{i−1}} is defined as g_{z}_{₀}_{, . . . , z}_{_{i−1}}. In this situation zᵢ₋₁ packets are requested initially by retransmission logic circuitry of a receiver STA and the time limit is Tᵢ₋₁. For example, the subtree circled is denoted by g_{z}_{₀}_{,z}_{₁} 2535, where initially z₁=l packets are requested by retransmission logic circuitry of a receiver STA and the time limit is T₁.

As the packet losses are random, some variables in the transmission process are also random. We use capitalized letters Xᵢ, Yᵢ, Zᵢ and Tᵢ to denote the random variables corresponding to the number of packets transmitted and received in round i, the number of packets missing at the receiver STA to enable decoding after round i (which can be expressed as Zᵢ=(Zᵢ₋₁−Yᵢ)⁺:=max(Zᵢ₋₁−Yᵢ,0)), and the remaining time after round i, respectively. The lowercase versions xᵢ, yᵢ, zᵢ and tᵢ denote the respective values in a particular realization of the transmission process. Sometimes some random variables are deterministic and the capital and small symbols coincide. For example, given a strategy g, since Z₀=k is deterministic, the number of transmitted packets in the first round X₁ is also deterministic. Thus X₁ is identical to its realization x₁. Similarly, T₁=t₁ and Z₀=z₀ (which is k).

Now we describe the performance metric recursions for both spectral efficiency and reliability.
1. As the time used to transmit the packets is random, when considering spectral efficiency, the retransmission logic circuitry of a transmitter STA may use the expected time used during the transmissions, which corresponds to the expected radio resource usage. Denote the expected time for a strategy g by σ_{k,T}(g), when initially an original set of k packets are scheduled to be sent to the receiver (i.e., Z₀=k) and the time limit is T. We have the following expression for the expected time usage:

$$\\ \begin{matrix}{σ}_{k , T} ( g ) = [ {\sum }_{i = 1}^{∞} ( {X}_{i} τ + {d}_{i}^{*} ) ] . & ( 1 )\end{matrix}$$

As described earlier dᵢ*=d if there is a feedback transmitted for round i, otherwise dᵢ*=0. If we define the function

$$\\ {1}_{\{ {X}_{i} > 0 , {T}_{i - 1} - {X}_{i} τ \geq d \}} = \{ \begin{matrix}1 , & if {X}_{i} > 0 \& {T}_{i - 1} - {X}_{i} τ \geq d \\ 0 , & otherwise\end{matrix}$$

(which evaluates to 1 only when in round i at least 1 packet is transmitted and there is time to transmit a feedback), then we can express dᵢ*=d*(Tᵢ₋₁,Xᵢ), where

d*(Tᵢ₋₁,Xᵢ):=d·1_{{X}_{ᵢ}_{>0,T}_{_{i−1}}_{-X}_{ᵢ}_{τ≥d}}.
The number of transmitted packets Xᵢ is determined by the function value of the strategy g on the branch B_{Z}_{₀}_{, . . . , Z}_{_{i−1}}:

Xᵢ=g(B_{Z}_{₀}_{, . . . ,Z}_{_{i−1}}),
and it is constrained by the remaining time Tᵢ₋₁:

Xᵢτ<Tᵢ₋₁.
The remaining time evolves as

T₀=T,

Tᵢ=Tᵢ₋₁−Xᵢτ−dᵢ*.
Furthermore, we have some extra boundary conditions: apart from Z₀=k we have Xᵢ₊₁=0 if Xᵢ=0, since if the retransmission logic circuitry of a transmitter STA determines not to transmit any packet in round i there is no round i+1.

With these definitions and expressions, we can derive the following recursion

$$\\ \begin{matrix}{σ}_{k , T} ( g ) = {x}_{1} τ + {d}^{*} ( T , {x}_{1} ) + {\sum }_{z = 1}^{k} Pr ( {Z}_{1} = z ) \cdot {σ}_{z , {t}_{1}} ( {g}_{k , z} ) , & ( 2 )\end{matrix}$$

where
x₁=g(B_{z}_{₀}) with z₀=k, and g_{k,z} denotes the sub-strategy g_{z}_{₀}_{,z}_{₁} with z₀=k and z₁=z.
The time t₁=T−x₁τ−d₁* is the remaining time after first round of transmission.
As the packet losses are independent and identically distributed random, Y₁ follows a binomial distribution and Z₁=(k−Y₁)⁺, we have

$$\\ Pr ( {Z}_{1} = z ) = \{ \begin{matrix}( \begin{matrix}{x}_{1} \\ k - z\end{matrix} ) {{e}_{r}^{{x}_{1} - k + z} ( 1 - {e}_{r} )}^{k - z} , & if z \geq k - {x}_{1} \& 1 \leq z \leq k \\ 0 , & otherwise\end{matrix} .$$

To successfully implement the recursion (2), the retransmission logic circuitry of the transmission STA may use more initial conditions, which are described later.
2. The reliability performance metric can be defined in more than one way, depending on the scenario and application.
   a) First, we consider the decoding failure probability η_{k,T}(g) for strategy g as the reliability metric, when initially k packets are to be sent to the receiver (i.e., Z₀=k) and the time limit is T. Since decoding failure happens for all cases of Z₁>0, we have the recursion

$$\\ \begin{matrix}{η}_{k , T} ( g ) = {\sum }_{z = 1}^{k} Pr ( {Z}_{1} = z ) \cdot {η}_{z , {t}_{1}} ( {g}_{k , z} ) , & ( 3 )\end{matrix}$$

where the terms are similarly defined as in equation (2).
b) Next, we consider the packet loss probability \tilde{η}_{k,T}(g) for the original set of k data packets when systematic network codes are used. If a data packet itself is lost in the transmission (with probability eᵣ), it can still be recovered if the decoding of the whole network code is successful. Hence, there are two chances of packet recovery and the probability \tilde{η}_{k,T}(g) can be calculated for the 1st data packet without loss of generality:

$$\\ \begin{matrix}{\tilde{η}}_{k , T} ( g ) = {e}_{r} \cdot {\sum }_{z = 1}^{k} Pr ( {Z}_{1} = z \vert packet 1 is lost ) \cdot {η}_{z , {t}_{1}} ( {g}_{k , z} ) , & ( 4 )\end{matrix}$$

where η_{z,t}_{₁} is defined in (3) and the probability term in (4) can be calculated as

$$\\ Pr ( {Z}_{1} = z \vert packet 1 is lost ) = \{ \begin{matrix}( \begin{matrix}{x}_{1} - 1 \\ k - z\end{matrix} ) {{e}_{r}^{{x}_{1} - 1 - k + z} ( 1 - {e}_{r} )}^{k - z} , & if z \geq k - {x}_{1} + 1 \& 1 \leq z \leq k \\ 0 , & otherwise\end{matrix} .$$

Here x₁ is defined similarly as in equation (2).
3. Although the equations (2)-(4) only describe the recursions for the first-round transmission, the expressions are similar for the remaining rounds by the retransmission logic circuitry of the transmitter STA which may replace k and T by z and t₁ respectively, and replace g by its sub-strategy g_{k,z} to obtain a subsequent recursion with its own constraints and conditions. Apart from the boundary conditions, more initial conditions to run these recursions may be:
   a) If x₁=g(B_{z}_{₀})=0 (for example, when T=0), then

σ_{k,T}(g)=0,η_{k,T}(g)=1, and \tilde{η}_{k,T}(g)=1
b) If x₁>0 but there is no time to transmit at least one packet in the next round, i.e., d*(T,x₁)=0 or d*(T,x₁)=d but t₁<τ, then

σ_{k,T}(g)=x₁τ+d*(T,x₁),

η_{k,T}(g)=F(x₁,k,eᵣ),

\tilde{η}_{k,T}(g)=eᵣ·F(x₁−1,k,eᵣ),
where F(x, k, eᵣ) is the decoding failure probability when a total of x packets are transmitted:

$$F ( x , k , {e}_{r} ) := {\sum }_{i = 0}^{k - 1} ( \begin{matrix}x \\ i\end{matrix} ) {( 1 - {e}_{r} )}^{i} {e}_{r}^{x - i} .$$

Note that the recursions (2)-(4) are all positive linear functions of the performance metrics of the sub-strategies g_{k,z} (i.e., g_{z}_{₀}_{,z}_{₁} with z₀=k and z₁=z), for 1≤z≤k. If one sub-strategy g_{k,z} is replaced by a better sub-strategy g_{k,z}′ in both performance metrics σ_{z,t}_{₁} and η_{z,t}_{₁}, then the performance metrics of the full strategy g will also improve, by the linear positive property of the recursive expressions. Hence, if a sub-strategy is not Pareto-optimal (i.e., outperformed by another sub-strategy in both metrics), then the full strategy cannot be Pareto-optimal either. By this reason the retransmission logic circuitry of the transmitter STA may perform Pareto optimization and prune the non-Pareto sub-strategies efficiently in each recursion when constructing the candidate set of potentially optimal schemes/strategies (see the algorithm below), without missing any Pareto-optimal strategies in the end result.

In many embodiments, the retransmission logic circuitry of the transmitter STA may comprise one or more algorithms to compute optimal network coding retransmission schemes such as a discrete case algorithm and a continuous case algorithm. For the discrete case algorithm, we first describe the optimization algorithms based on the recursions (2)-(4) to find the Pareto-optimal set, dividing into two cases. Then if we want to further reduce the complexity of these algorithms, we introduce a quantization-based thinning process that prunes the set of the potentially optimal schemes in each iteration to achieve a flexible trade-off between complexity and optimality. At the end of this section, we also provide an example for the 2-step optimization 2500 in FIG. 2F.

The retransmission logic circuitry of a STA may use the discrete case algorithm when all time parameters are multiples of a common unit time. If all time parameters T, i and d in the problem are integer multiples of a unit time Δ, then the Pareto optimization can be iteratively performed for the data size k′=1, 2, . . . , k and for time limit T′=Δ, 2Δ, . . . , T.

For each pair of parameters (k′,T′) the algorithm constructs the set of Pareto-optimal schemes [symbol] (k′,T′) and records their performance metrics based on the outcome from the previous iterations as follows:

When T′=Δ, since there is no time for feedback and retransmission, each possible scheme only consists of a strategy g that decides how many packets x₁ to transmit for the first round, subject to the time limit X₁τ<T₀=T′. This means that in graph 2400, the tree g only has one layer and there are no sub-strategies/subtrees. In this case, the retransmission logic circuitry of the transmitter STA forms the set of all candidate strategies S(k′,T′) and finds the corresponding performances. Then, the retransmission logic circuitry of the transmitter STA may remove the non-Pareto-optimal schemes based on their performance metrics. Specifically, for a scheme g, if there exists another scheme h such that either

σ_{k′,T′}(h)≤σ_{k′,T′}(g) and η_{k′,T′}(h)<η_{k′,T′}(g)

or

σ_{k′,T′}(h)<σ_{k′,T′}(g) and η_{k′,T′}(h)≤η_{k′,T′}(g),

then g is removed from S(k′,T′). The remaining schemes in S(k′,T′) after this process form the resulting Pareto optimal set [symbol] (k′,T′).

When T′>Δ, a strategy g may have sub-strategies as there might be time for feedback and retransmissions after transmitting x₁ packets for the first round transmission. If that is the case, then for each positive value of z₁ (the number of packets still needed at the receiver STA for decoding the original set of k packets after the first round transmission), a corresponding sub-strategy g_{k′,z}_{₁} determines what the retransmission scheme does in the following rounds. Thus, a retransmission scheme comprises a first-round strategy and k′ sub-strategies (since 1≤z₁≤k′), which are represented in graph 2400 in FIG. 2H by the branch B_{z}_{₀} and the k′ subtrees g_{k′,1} 2540, g_{k′,l} 2545, . . . , g_{k′,k′}2550, respectively.

As the sub-strategies g_{k′,z}_{₁} all have a time limit T₁<T′ and data size z₁≤k′, by the recursive nature of the algorithm, the corresponding Pareto-optimal set [symbol] (z₁,T₁) has already been computed in the previous iterations. So we can construct the Pareto optimal set [symbol] (k′,T′) for the current iteration as follows:
a) For each possible x₁ that does not violate the time constraint, the retransmission logic circuitry of the transmitter STA may calculate the corresponding T₁. If there is no time for retransmission, then the retransmission logic circuitry of the transmitter STA may construct a scheme g by setting its first round transmission to be x₁ packets. Otherwise, for each combination of sub-strategies g_{k′,1}∈ [symbol] (1, T₁), . . . , g_{k′,k′}∈ [symbol] (k′,T₁), i.e., each element in the Cartesian product [symbol] (1,T₁)× . . . × [symbol] (k′,T₁), the retransmission logic circuitry of the transmitter STA may construct a scheme g by setting the first round transmission to be x₁ packets and using g_{k′,1}, . . . , g_{k′,k′} as the sub-strategies for its subsequent rounds of transmissions (retransmissions).
b) The retransmission logic circuitry of the transmitter STA may then construct the candidate set S(k′,T′) by including all strategies g formed in the previous action and, for each of the strategies g, compute the corresponding performances.
c) Next, as before, the retransmission logic circuitry of the transmitter STA may remove the non-Pareto-optimal schemes from S(k′,T′) based on the performance metrics. The remaining schemes are then the Pareto optimal set [symbol] (k′,T′).

Note that to make the pruning more efficient, in a) the retransmission logic circuitry of the transmitter STA may recursively form the Cartesian product [symbol] (1,T₁)× . . . × [symbol] (k′,T₁) by including only one set at a time, and during each recursion, the retransmission logic circuitry of the transmitter STA may also prune the intermediate results by removing the non-Pareto-optimal product schemes (based on the corresponding partial sums in equations (2)-(4)).

In the descriptions above, we only used the decoding failure probability η_{k′,T′} as the reliability measure. If systematic network codes are used and the packet loss probability \tilde{η}_{k′,T′} is considered as the reliability measure, then the retransmission logic circuitry of the transmitter STA may still run the above iterations with the performance metrics σ_{k′,T′} and η_{k′,T′} for all but the last iteration (when k′=k and T′=T), due to the recursive formula (4). For the last iteration, the retransmission logic circuitry of the transmitter STA may use σ_{k′,T′} and \tilde{η}_{k′,T′} to prune the results.

FIG. 2I illustrates an embodiment of a graph 2600 of the implementation for the continuous case algorithm. When all the time parameters are not integer multiples of a common unit time Δ, or such a unit time can be found but it is too small compared to all T, τ and d, then running the iterations above for the time list T′=Δ, 2Δ, . . . , T is either impossible or computationally inefficient. In this case, we may adapt the discrete case algorithm to make it suitable for the continuous time parameters (the continuous case algorithm).

We consider all durations of time that a scheme could possibly use during the transmission process within the time limit T. The time used is τ for each packet transmitted, and is d for the transmission of a feedback. Hence, if in the transmission process the total number of packets transmitted is nₚₖₜ and the total number of feedback is n_{fb}, then the respective durations of time incurred are Tₚₖₜ=nₚₖₜ·τ and T_{fb}=n_{fb}·d, and the total time used is Tₚₖₜ+T_{fb}. However, not all combinations of nₚₖₜ and n_{fb} are possible in the transmission process, as we have at least two constraints: i) the total time should not exceed the time limit T, and ii) the number of feedback values should not exceed the number of transmitted packets, as a feedback value should follow a transmission of at least one packet. That is,

Tₚₖₜ+T_{fb}=nₚₖₜ·τ+n_{fb}·d≤T,

n_{fb}≤nₚₖₜ.

The valid combinations for nₚₖₜ and n_{fb} are illustrated in graph 2600, which are the positive grid points that lie on or below both the lines of nₚₖₜ·τn_{fb}·d=T and nₚₖₜ=n_{fb}. Collecting the total time used (i.e., Tₚₖₜ+T_{fb}) for each of these combinations, the retransmission logic circuitry of the transmitter STA may arrive at a list of allowed time durations, L(T)={T₁^{L}, T₂^{L}, . . . , T_{N}_{_{L}}^{L}}, sorted in ascending order, whose total number of entries is denoted by N_{L}.

With the list of times L(T), the retransmission logic circuitry of the transmitter STA may iteratively perform the Pareto optimization similarly as the discrete case above, for data size k′=1, 2, . . . , k and for time limit T′=T₁^{L}, T₂^{L}, . . . , T_{N}_{_{L}}^{L}, with one more adaptation: in b) the sub-strategies are selected from the Pareto optimal sets [symbol] (1,Tᵢ^{L}), . . . [symbol] (k′,Tᵢ^{L}), where Tᵢ^{L} is the largest entry in the list L(T) that does not exceed T₁, the remaining time after the first transmission.

By reducing the sub-strategy time limit from T₁ to Tᵢ¹ we do not lose optimality, since we have not missed any valid schemes: in fact, if a scheme complies with the time limit T₁, then it must also do so with the time limit Tᵢ^{L}. Otherwise, it can achieve a time duration t with Tᵢ^{L}<t≤T₁. Since L(T) includes all possible time durations, t∈L(T) and we have found a larger entry in L(T) than Tᵢ^{L} that does not exceed T₁, which is a contradiction.

After all iterations are finished, the resulting Pareto optimal set [symbol] (k,T) is set to be the outcome [symbol] (k,T_{N}_{_{L}}^{L}) of the final iteration, for the same reason above.

In some embodiments, the retransmission logic circuitry of a STA may also perform Quantization-based thinning. Sometimes, if k and/or T are large, the size of the Pareto-optimal set [symbol] (k,T) still becomes too large to be computed efficiently (although it is already significantly smaller than the total number of schemes). In this case, we can trade off optimality with computational complexity by the retransmission logic circuitry of the transmitter STA thinning the Pareto-optimal set in each iteration. In other words, instead of the whole optimal rate-reliability “curve” we may only obtain some representative points on it. As long as the density of the representative points on the curve is still enough for practical use (for example, we may not be interested in obtaining two schemes with the same reliability performance and with only 0.1% difference in the spectral efficiency performance), we can greatly improve the computation efficiency by reducing the set size.

The retransmission logic circuitry of the transmitter STA may achieve such thinning by quantizing the performances of each scheme in each iteration and removing the schemes with duplicated quantized performances. (Note that quantization may be used for thinning but might not be used for the performance calculation recursions.) Specifically, we can define the quantization precision δ₁ and δ₂ for the rate and reliability measures respectively, and quantize the corresponding performance metrics based on them. For example, the retransmission logic circuitry of the transmitter STA may quantize the normalized expected time σ_{k,T}/k using precision δ₁, or quantize its inverse (which corresponds to spectral efficiency). For the reliability measure, the retransmission logic circuitry of the transmitter STA may quantize the algorithm of η_{k,T} or \tilde{η}_{k,T}. After thinning, Pareto optimization can also be performed to further reduce the set size, using the quantized performances.

In an example scenario for two step optimization, we require minimal usage of radio resources (i.e., maximizing spectral efficiency) to achieve a given level of reliability. The retransmission logic circuitry of the STA may first find the optimal rate-reliability “curve”, i.e., the Pareto optimal set [symbol] (k,T) using the procedure above. Then the retransmission logic circuitry of the STA may select all schemes in [symbol] (k,T) whose reliability performance satisfies the given requirement. Among these schemes, the retransmission logic circuitry of the STA may use any suitable algorithm such as sorting and/or searching algorithms to find the one with the shortest expected time σ_{k,T}, which achieves the minimal radio resource usage.

FIGS. 2J and 2K illustrate embodiments of numerical results for the discrete case algorithm and a practical Wi-Fi configuration that requires the continuous case algorithm. FIG. 2J illustrates an embodiment of a graph 2700 for rate-reliability performances for a discrete case algorithm example. For a simple discrete scenario, we compare the reliability and spectral efficiency performances of different schemes/algorithms. In this scenario the number of data packets to be delivered is k=4, time limit is T=14 slots, while the transmission of a packet and that of a feedback both take 1 slot (i.e., τ=d=1). The erasure probability of each packet transmission is eᵣ=0.1. We plot the performances of the currently used selective retransmission scheme (SelReTx), the optimal network coding retransmission scheme (NC OptReTx) when there is no time limit, and two heuristic network coding retransmission schemes: transmitting the exact number of missing packets (NC AdpReTx0), and over-provisioning to account for the packet loss rate eᵣ (NC AdpReTxExpRound), i.e., transmitting

$$round ( \frac{z}{1 - {e}_{r}} )$$

if packets are reported to be missing at the receiver. In addition, we plot (in circles) all Pareto-optimal network coding retransmission schemes obtained using the discrete case algorithm. We can see that using our Pareto optimization algorithm we can discover many previously unknown schemes that achieve much better reliability performance (e.g., <10⁻⁷ instead of ˜10⁻⁵) with only slightly lower spectral efficiency (<0.5%), compared to the known schemes.

FIG. 2K illustrates an embodiment of a graph 2700 for rate-reliability performances for a practical WiFi configuration for a continuous case algorithm example. For this embodiment, the packet loss rate eᵣ=0.1, the packet size is 200 bytes, and the data rate (PHY rate) for transmitting the packets is 24 Mbps. The time constraint for the transmission process of the retransmission scheme is one TXOP (transmission opportunity), which has a duration of T=1 ms. The BlockAck for selective retransmission uses 8 octets for the bitmap, while the new network coding BlockAck only uses 1 octet for reporting the number of missing packets to enable decoding. In this embodiment, the continuous adaptation of the discrete case algorithm is used for the Pareto optimization since the time parameters are continuous. Quantization-based thinning is also performed here to reduce computation complexity.

In graph 2700, the reliability and spectral efficiency performances of the selective retransmission scheme and the Pareto optimal network coding retransmission schemes are plotted for different values of k, where we perform another round of Pareto optimization for the union of all Pareto optimal sets [symbol] (k,T) to obtain the overall Pareto optimal schemes (regardless of the value of k). We can see that we can discover many good network coding retransmission schemes using the continuous case algorithm, which outperforms the existing selective retransmission scheme by a large margin (for example, with even higher spectral efficiency the reliability is improved from ˜10⁻⁷ to ˜10⁻¹²).

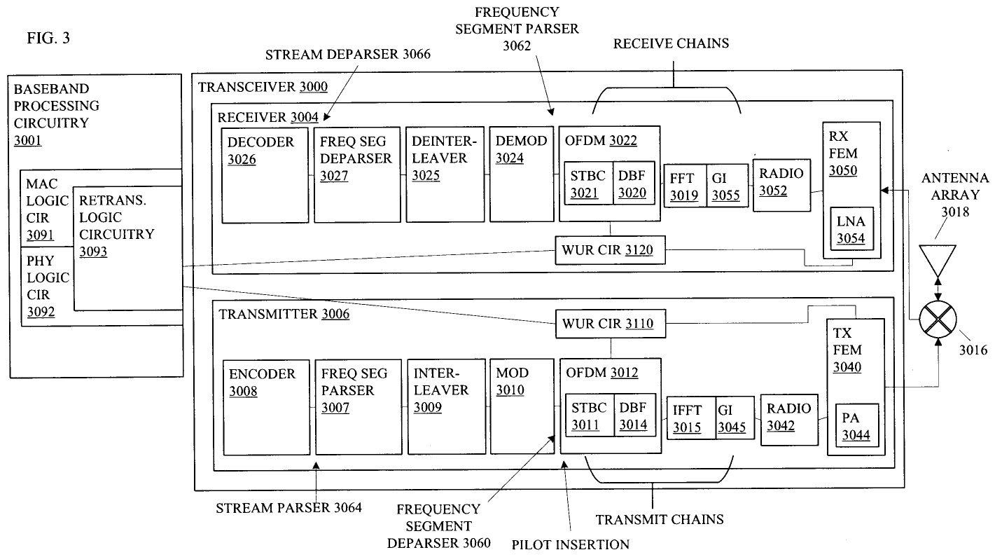

FIG. 3 depicts an embodiment of an apparatus to generate, transmit, receive, and interpret or decode PHY frames and MAC frames. The apparatus comprises a transceiver 3000 coupled with baseband processing circuitry 3001. The baseband processing circuitry 3001 may comprise a MAC logic circuitry 3091 and PHY logic circuitry 3092. Retransmission logic circuitry 3093 may reside in the MAC logic circuitry 3091 or in both the MAC logic circuitry 3091 and the PHY logic circuitry 3092. In other embodiments, the baseband processing circuitry 3001 may be included on the transceiver 3000.

The MAC logic circuitry 3091 and PHY logic circuitry 3092 may comprise code executing on processing circuitry of a baseband processing circuitry 3001; circuitry to implement operations of functionality of the MAC or PHY; or a combination of both. In the present embodiment, the MAC logic circuitry 3091 and PHY logic circuitry 3092 may comprise retransmission logic circuitry 3093 to implement a retransmission scheme. For example, the retransmission logic circuitry of an AP MLD and a non-AP MLD may implement network coding to encode and decode network coded packets in one or more round of transmission and retransmission to communicate an original set of k packets between the AP MLD and the non-AP MLD.

The MAC logic circuitry 3091 may determine a frame such as a MAC management frame and the PHY logic circuitry 3092 may determine the physical layer protocol data unit (PPDU) by prepending the frame, also called a MAC protocol data unit (MPDU), with a physical layer (PHY) preamble for transmission of the MAC management frame via the antenna array 3018. The PHY logic circuitry 3092 may cause transmission of the MAC management frame in the PPDU.

The transceiver 3000 comprises a receiver 3004 and a transmitter 3006. Embodiments have many different combinations of modules to process data because the configurations are deployment specific. FIG. 3 illustrates some of the modules that are common to many embodiments. In some embodiments, one or more of the modules may be implemented in circuitry separate from the baseband processing circuitry 3001. In some embodiments, the baseband processing circuitry 3001 may execute code in processing circuitry of the baseband processing circuitry 3001 to implement one or more of the modules.

In the present embodiment, the transceiver 3000 also includes WUR circuitry 3110 and 3120. The WUR circuitry 3110 may comprise circuitry to use portions of the transmitter 3006 (a transmitter of the wireless communications I/F such as wireless communications I/Fs 1216 and 1246 of FIG. 1C) to generate a WUR packet. For instance, the WUR circuitry 3110 may generate, e.g., an OOK signal with OFDM symbols to generate a WUR packet for transmission via the antenna array 3018. In other embodiments, the WUR may comprise an independent circuitry that does not use portions of the transmitter 3006.

Note that a MLD such as the AP MLD 1210 in FIG. 1C may comprise multiple transmitters to facilitate concurrent transmissions on multiple contiguous and/or non-contiguous carrier frequencies.

The transmitter 3006 may comprise one or more of or all the modules including an encoder 3008, a stream deparser 3066, a frequency segment parser 3007, an interleaver 3009, a modulator 3010, a frequency segment deparser 3060, an OFDM 3012, an Inverse Fast Fourier Transform (IFFT) module 3015, a GI module 3045, and a transmitter front end 3040. The encoder 3008 of transmitter 3006 receives and encodes a data stream destined for transmission from the MAC logic circuitry 3091 with, e.g., a binary convolutional coding (BCC), a low-density parity check coding (LDPC), and/or the like. After coding, scrambling, puncturing and post-FEC (forward error correction) padding, a stream parser 3064 may optionally divide the data bit streams at the output of the FEC encoder into groups of bits. The frequency segment parser 3007 may receive data stream from encoder 3008 or streams from the stream parser 3064 and optionally parse each data stream into two or more frequency segments to build a contiguous or non-contiguous bandwidth based upon smaller bandwidth frequency segments. The interleaver 3009 may interleave rows and columns of bits to prevent long sequences of adjacent noisy bits from entering a BCC decoder of a receiver.

The modulator 3010 may receive the data stream from interleaver 3009 and may impress the received data blocks onto a sinusoid of a selected frequency for each stream via, e.g., mapping the data blocks into a corresponding set of discrete amplitudes of the sinusoid, or a set of discrete phases of the sinusoid, or a set of discrete frequency shifts relative to the frequency of the sinusoid. In some embodiments, the output of modulator 3010 may optionally be fed into the frequency segment deparser 3060 to combine frequency segments in a single, contiguous frequency bandwidth of, e.g., 320 MHz. Other embodiments may continue to process the frequency segments as separate data streams for, e.g., a non-contiguous 160+160 MHz bandwidth transmission.

After the modulator 3010, the data stream(s) are fed to an OFDM 3012. The OFDM 3012 may comprise a space-time block coding (STBC) module 3011, and a digital beamforming (DBF) module 3014. The STBC module 3011 may receive constellation points from the modulator 3010 corresponding to one or more spatial streams and may spread the spatial streams to a greater number of space-time streams. Further embodiments may omit the STBC.

The OFDM 3012 impresses or maps the modulated data formed as OFDM symbols onto a plurality of orthogonal subcarriers, so the OFDM symbols are encoded with the subcarriers or tones. The OFDM symbols may be fed to the DBF module 3014. Generally, digital beam forming uses digital signal processing algorithms that operate on the signals received by, and transmitted from, an array of antenna elements. Transmit beamforming processes the channel state to compute a steering matrix that is applied to the transmitted signal to optimize reception at one or more receivers. This is achieved by combining elements in a phased antenna array in such a way that signals at particular angles experience constructive interference while others experience destructive interference.

The IFFT module 3015 may perform an inverse discrete Fourier transform (IDFT) on the OFDM symbols to map on the subcarriers. The guard interval (GI) module 3045 may insert guard intervals by prepending to the symbol a circular extension of itself. The GI module 3045 may also comprise windowing to optionally smooth the edges of each symbol to increase spectral decay.

The output of the GI module 3045 may enter the radio 3042 to convert the time domain signals into radio signals by combining the time domain signals with subcarrier frequencies to output into the transmitter front end module (TX FEM) 3040. The transmitter front end 3040 may comprise a with a power amplifier (PA) 3044 to amplify the signal and prepare the signal for transmission via the antenna array 3018. In many embodiments, entrance into a spatial reuse mode by a communications device such as a STA may reduce the amplification by the PA 3044 to reduce channel interference caused by transmissions.

The transceiver 3000 may also comprise duplexers 3016 connected to antenna array 3018. The antenna array 3018 radiates the information bearing signals into a time-varying, spatial distribution of electromagnetic energy that can be received by an antenna of a receiver. In several embodiments, the receiver 3004 and the transmitter 3006 may each comprise its own antenna(s) or antenna array(s).

The transceiver 3000 may comprise a receiver 3004 for receiving, demodulating, and decoding information bearing communication signals. The receiver 3004 may comprise a receiver front-end module (RX FEM) 3050 to detect the signal, detect the start of the packet, remove the carrier frequency, and amplify the subcarriers via a low noise amplifier (LNA) 3054 to output to the radio 3052. The radio 3052 may convert the radio signals into time domain signals to output to the GI module 3055 by removing the subcarrier frequencies from each tone of the radio signals.

The receiver 3004 may comprise a GI module 3055 and a fast Fourier transform (FFT) module 3019. The GI module 3055 may remove the guard intervals and the windowing and the FFT module 3019 may transform the communication signals from the time domain to the frequency domain.

The receiver 3004 may also comprise an OFDM 3022, a frequency segment parser 3062, a demodulator 3024, a deinterleaver 3025, a frequency segment deparser 3027, a stream deparser 3066, and a decoder 3026. An equalizer may output the weighted data signals for the OFDM packet to the OFDM 3022. The OFDM 3022 extracts signal information as OFDM symbols from the plurality of subcarriers onto which information-bearing communication signals are modulated.

The OFDM 3022 may comprise a DBF module 3020, and an STBC module 3021. The received signals are fed from the equalizer to the DBF module 3020. The DBF module 3020 may comprise algorithms to process the received signals as a directional transmission directed toward to the receiver 3004. And the STBC module 3021 may transform the data streams from the space-time streams to spatial streams.

The output of the STBC module 3021 may enter a frequency segment parser 3062 if the communication signal is received as a single, contiguous bandwidth signal to parse the signal into, e.g., two or more frequency segments for demodulation and deinterleaving.

The demodulator 3024 demodulates the spatial streams. Demodulation is the process of extracting data from the spatial streams to produce demodulated spatial streams. The deinterleaver 3025 may deinterleave the sequence of bits of information. The frequency segment deparser 3027 may optionally deparse frequency segments as received if received as separate frequency segment signals or may deparse the frequency segments determined by the optional frequency segment parser 3062. The decoder 3026 decodes the data from the demodulator 3024 and transmits the decoded information, the MPDU, to the MAC logic circuitry 3091.

The MAC logic circuitry 3091 may parse the MPDU based upon a format defined in the communications device for a frame to determine the particular type of frame by determining the type value and the subtype value. The MAC logic circuitry 3091 may then interpret the remainder of MPDU.

While the description of FIG. 3 focuses primarily on a single spatial stream system for simplicity, many embodiments are capable of multiple spatial stream transmissions and use parallel data processing paths for multiple spatial streams from the PHY logic circuitry 3092 through to transmission. Further embodiments may include the use of multiple encoders to afford implementation flexibility.

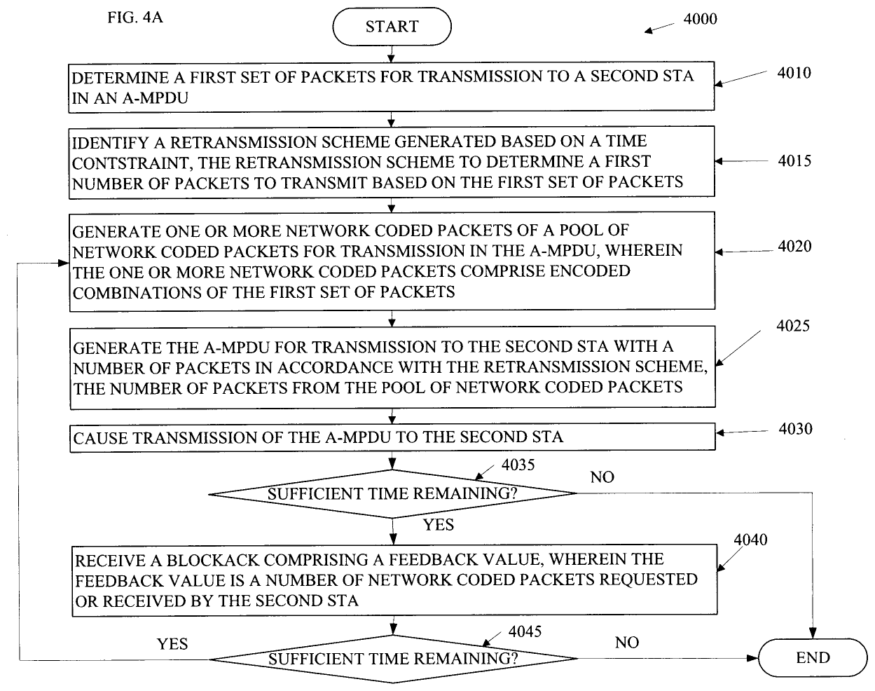

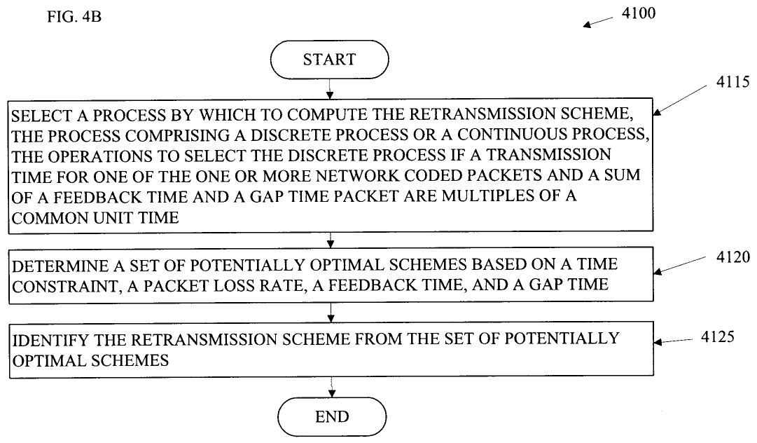

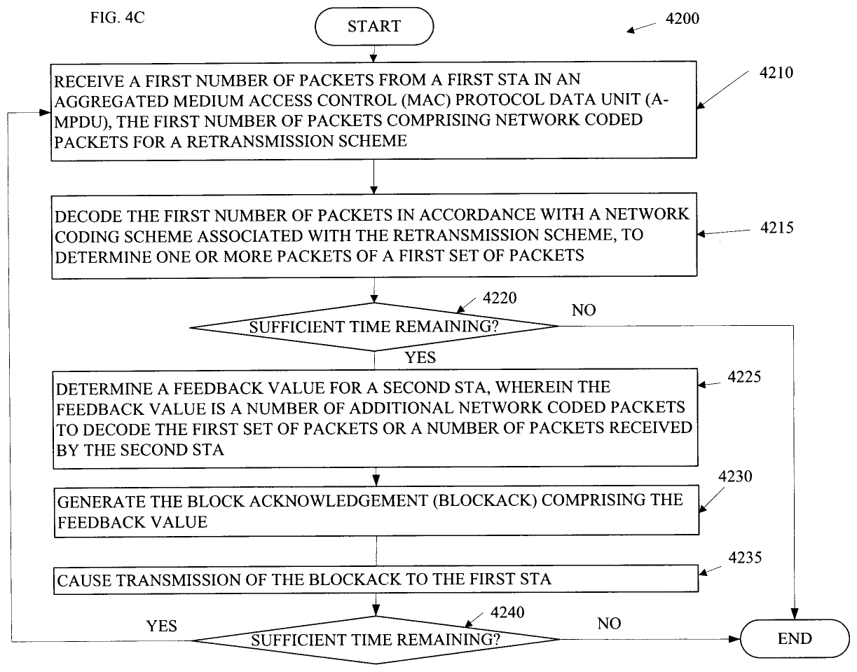

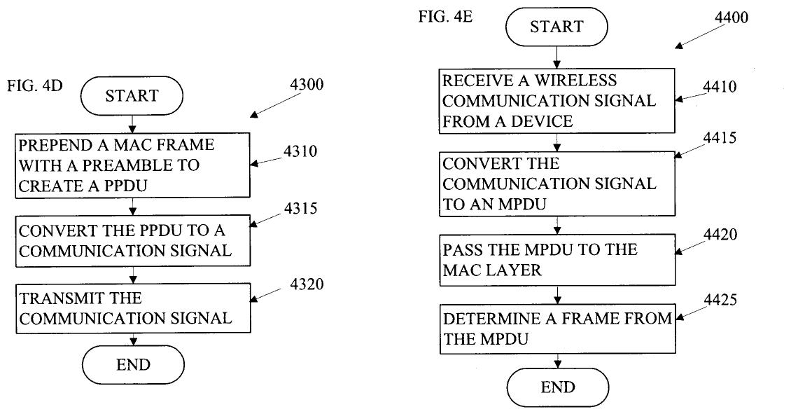

FIG. 4A depicts an embodiment of a flowchart of a process 4000 to implement retransmission logic circuitry such as the retransmission logic circuitry discussed in FIGS. 1-3. At element 4010, retransmission logic circuitry of an AP MLD (e.g., the retransmission logic circuitry 1220 of the AP MLD 1210) may receive or otherwise identify a set of k data packets to transmit to a non-AP MLD (e.g., the retransmission logic circuitry 1250 of the AP MLD 1230). Note that prior to the first transmission, the non-AP MLD still needs to receive z₀=k network coded packets.

The retransmission logic circuitry of the AP MLD may identify a retransmission scheme generated based on a time constraint, the retransmission scheme to determine a first number of packets (x₁) to transmit based on the first set of k packets (element 4015). In other words, the retransmission scheme may have a retransmission strategy g that identifies a first number (x₁) of network coded packets to transmit to the non-AP MLD. Note that the retransmission strategy g is based on the requirement to transmit z0 (which equals k) packets to the non-AP MLD.

The retransmission logic circuitry of the AP MLD may encode the original set of k data packets with a network code, a linear packet-level coding having a maximum distance separable (MDS) property, to generate one or more network coded packets of a pool of network coded packets for transmission in an A-MPDU (element 4020). The one or more network coded packets may comprise encoded combinations of the original set of k packets. In some embodiments, the network coding process is systematic, concatenating the original set of k packets with network coded packets.

During or after generation of the first number (x₁) of network coded packets, the retransmission logic circuitry of the AP MLD may generate the A-MPDU for transmission to the second STA with the first number (x₁) of network coded packets (element 4025). The first number (x₁) of network coded packets may comprise at least one of the one or more network coded packets from the pool of network coded packets. Note also that x₁ may be greater than z₀, less than z₀, or equal to z₀ in accordance with the retransmission scheme.

During or after generation of the A-MPDU, the retransmission logic circuitry of the AP MLD may pass the A-MPDU (or portions thereof) to the PHY to cause transmission of the A-MPDU to the non-AP MLD (element 4030). If sufficient time remains (element 4035) in accordance with the time constraint (T) after transmission of the A-MPDU to the non-AP MLD, the AP MLD may receive a feedback value from the non-AP MLD in a BlockAck (element 4040). Otherwise, the retransmission scheme for the original set of k data packets may end.

Note that the AP MLD may determine from the feedback value, the number of packets received by the non-AP MLD so z₁=k minus the number of network coded packets received by non-AP MLD. The retransmission logic circuitry of the AP MLD may select a substrategy of g based on z₁ to determine a second number (x₂) of packets to transmit to the non-AP MLD in the first retransmission.

If sufficient time remains (element 4045) in accordance with the time constraint (T) after transmission of the BlockAck to the non-AP MLD, the AP MLD may generate the second number (x₂) of network coded packets of the pool of network coded packets (element 4020), generate a second A-MPDU with the second number (x₂) of network coded packets (element 4025), and cause transmission of the second A-MPDU to the non-AP MLD (element 4030). This recursive process from element 4020 through element 4045 may repeat until there is insufficient time to transmit an A-MPDU or a feedback value in a BlockAck, the feedback value indicates that the non-AP MLD received at least k packets, or the retransmission scheme for the original set of k data packets otherwise determines to terminate or end.

Note that during recursion, the retransmission logic circuitry of the AP MLD may determine the values z₂, z₃, z₄, . . . based on the respective feedback values from the non-AP MLD. The retransmission logic circuitry of the AP MLD may select each of the substrategies of the retransmission scheme based on the respective values z₂, z₃, z₄, . . . and each of the substrategies may define the respective numbers x₃, x₄, x₅, . . . of network coded packets to transmit during the respective retransmissions.

FIG. 4B depicts another embodiment of a flowchart of a process 4100 to implement retransmission logic circuitry such as the retransmission logic circuitry discussed in FIGS. 1-3. At element 4110, retransmission logic circuitry of an AP MLD (e.g., the retransmission logic circuitry 1220 of the AP MLD 1210 shown FIG. 1C) may select a process by which to compute the retransmission scheme (element 4115). The process may comprise a discrete process (such as the discrete case algorithm discussed in conjunction with FIGS. 2A-2K) or a continuous process (such as the continuous case algorithm discussed in conjunction with FIGS. 2A-2K). In many embodiments, the retransmission logic circuitry of an AP MLD may select the discrete process if a transmission time for one of the one or more network coded packets and a sum (d) of a feedback time and a gap time are multiples of a common unit time.

After selecting the process by which to compute the retransmission scheme, the retransmission logic circuitry of the AP MLD may determine a set of potentially optimal schemes, P(k′,T), based on a time constraint (T), a packet loss rate (eᵣ), a feedback time, and a gap time (element 4120).

After determining the set of potentially optimal schemes, P(k′,T), the AP MLD may identify the retransmission scheme from the set of potentially optimal schemes (element 4125) by, identifying the retransmission scheme with e.g., the shortest expected time usage.

Thereafter, the retransmission logic of the AP MLD may implement a process 4000 such as the flowchart shown in FIG. 4A to communicate packets of a data stream to a non-AP MLD. Note that while this embodiment and other embodiments discuss an AP MLD or an AP STA performing the processes 4000 and 4100 in the flowcharts shown in FIGS. 4A and 4B, a non-AP MLD, non-AP STA, or any other wireless device may perform the processes 4000 and/or 4100 described in the flowcharts shown in FIGS. 4A and 4B.

FIG. 4C depicts another embodiment of a flowchart of a process 4200 to implement retransmission logic circuitry such as the retransmission logic circuitry discussed in FIGS. 1-3 and 4A-4B. At element 4210, retransmission logic circuitry of a second STA (e.g., the retransmission logic circuitry 1250 of MLD STA 1230 shown FIG. 1C) may receive a first number of packets from a first STA (e.g., the retransmission logic circuitry 1220 of AP MLD 1210 shown FIG. 1C) in an aggregated medium access control (MAC) protocol data unit (A-MPDU). The first number of packets may comprise network coded packets for a retransmission scheme (element 4210) for transmission from the first STA of an original set of k packets.

At 4215, the retransmission logic circuitry of the second STA may decode the first number of packets in accordance with a network coding scheme associated with the retransmission scheme, to determine one or more packets of the original set of k packets. If sufficient time remains in a time constraint (T) for the retransmission scheme (element 4220), the retransmission logic circuitry of the second STA may determine a feedback value (e.g., k-k′) to send to the first STA. The feedback value may be a number of additional network coded packets to decode the original set of k packets or a number of network coded packets received by the second STA.

After or during the determination of the feedback value, the retransmission logic circuitry of the second STA may generate the block acknowledgement (BlockAck) comprising the feedback value (element 4230) and cause transmission of the BlockAck to the first STA (element 4235). If sufficient time remains in the time constraint (T) and the feedback value does not indicate that the second STA received enough network coded packets to decode the entire original set of k packets, the second STA may receive a first retransmission with a second number of network coded packets (element 4210) and decode the second number of packets (element 4215). If sufficient time remains in a time constraint (T) for the retransmission scheme (element 4220), the retransmission logic circuitry of the second STA may determine a feedback value to send to the first STA, generate a BlockAck with the feedback value (element 4230), and cause transmission of the BlockAck to the first STA (element 4235). This recursive process may continue from element 4210 through element 4240 until the second STA receives a sufficient number of network coded packets to decode the entire set of original k packets, until the second STA responds with a feedback value that indicates the second STA received a sufficient number of network coded packets to decode the entire set of original k packets, until there is insufficient time within the time constraint (T) to send the BlockAck, until there is insufficient time within the time constraint (T) for the second STA to receive another retransmission of network coded packets, or until the first STA determines to terminate the retransmission scheme for the original set of k packets.

FIGS. 4D-E depict embodiments of flowcharts 4300 and 4300 to transmit, receive, and interpret communications with a frame. Referring to FIG. 4D, the flowchart 4300 may begin with transmitting a MAC A-MPDU frame from the wireless communications I/F 1216 of the AP STA 1210 to the wireless communications I/Fs (such as wireless communications I/F 1246 of the STA 1230, STA 1290, STA 1292, and STA 1296 as shown in FIG. 1C. The MAC logic circuitry, such as the MAC logic circuitry 3091 in FIG. 1C, of each STA of STA 1230, STA 1290, STA 1292, and STA 1296 may operate in conjunction with retransmission logic circuitry 3093 to generate a MAC BlockAck frame to transmit to the AP STA 1210 in response to the A-MPDU to indicate a number of packets received or a number of packets needed to decode a full set of packets and may pass the frame as an MAC protocol data unit (MPDU) to a PHY logic circuitry such as the PHY logic circuitry 3092 in FIG. 1C as a PSDU to include in a PHY frame. The PHY logic circuitry may also encode and transform the PSDU into OFDM symbols for transmission to the AP STA 1210. The PHY logic circuitry may generate a preamble to prepend the PHY service data unit (PSDU) (the MPDU) to form a PHY protocol data unit (PPDU) for transmission (element 4310).

A physical layer device such as the transmitter 3006 in FIG. 3 or the wireless network interfaces 1222 and 1252 in FIG. 1A may convert the PPDU to a communication signal via RF circuitry of a radio (element 4315). The transmitter may then transmit the communication signal via a front-end module to pre-condition and amplify the communication signal for transmission via the antenna (element 4320).

Referring to FIG. 4E, the flowchart 4400 begins with a receiver of a device such as the receiver 3004 in FIG. 3 receiving a communication signal via one or more antenna(s) such as an antenna element of antenna array 3018 (element 4410). The receiver may convert the communication signal into an MPDU in accordance with the process described in the preamble (element 4415). More specifically, the received signal is fed from the one or more antennas to a DBF such as the DBF 220. The DBF transforms the antenna signals into information signals. The output of the DBF is fed to OFDM such as the OFDM 3022 in FIG. 3. The OFDM extracts signal information from the plurality of subcarriers onto which information-bearing signals are modulated. Then, the demodulator such as the demodulator 3024 demodulates the signal information via, e.g., BPSK, 16-QAM (quadrature amplitude modulation), 64-QAM, 256-QAM, 1024-QAM, or 4096-QAM with a forward error correction (FEC) coding rate (1/2, 2/3, 3/4, or And the decoder such as the decoder 3026 decodes the signal information from the demodulator via, e.g., BCC or LDPC, to extract the MPDU and pass or communicate the MPDU to MAC layer logic circuitry such as MAC logic circuitry 3091 (element 4420).

When received at the MAC logic circuitry, the MPDU may be a MAC Service Data Unit (MSDU). The MAC logic circuitry in conjunction with retransmission logic circuitry may determine frame field values from the MSDU (MPDU from PHY) (element 4425) such as the feedback value in the BlockAck frame shown in FIG. 2B. The MAC logic circuitry may determine frame field values such as the type and subtype field values to determine that the MAC frame is the BlockAck frame and, more specifically, a BlockAck frame with a feedback value that is the number of packets received by or the number of packets still needed by a STA to decode a full set of packets encoded in the packets received.

FIG. 5 shows a functional diagram of an exemplary communication station 500, in accordance with one or more example embodiments of the present disclosure. In one embodiment, FIG. 5 illustrates a functional block diagram of a communication station that may be suitable for use as an AP STA 1005 (FIG. 1A) or a user device 1024 (FIG. 1A) in accordance with some embodiments. The communication station 500 may also be suitable for use as other user device(s) 1020 such as the user devices 1025 and/or 1026. The user devices 1024 and 1025 may include, e.g., a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting MAC and PHY message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

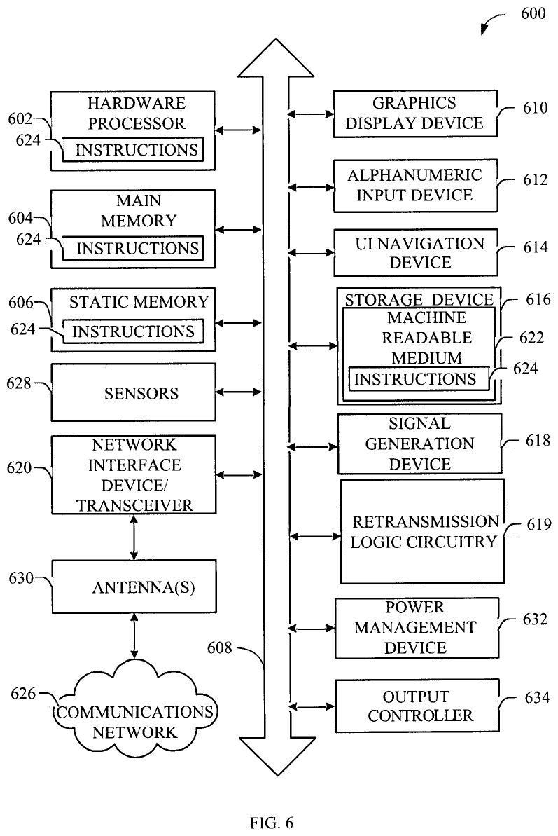

FIG. 6 illustrates a block diagram of an example of a machine 600 or system upon which any one or more of the techniques (e.g., methodologies) discussed herein may be performed. For instance, the machine may comprise any STAs discussed in conjunction with FIGS. 1-5. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a non-AP STA or an AP STA in network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as link management. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some of or all which may communicate with each other via one or more interlinks (e.g., buses or high-speed interconnects) 608. Note that the single set of interlinks 608 may be representative of the physical interlinks in some embodiments but is not representative of the physical interlinks 608 in other embodiments. For example, the main memory 604 may couple directly with the hardware processor 602 via high-speed interconnects or a main memory bus. The high-speed interconnects typically connect two devices, and the bus is generally designed to interconnect two or more devices and include an arbitration scheme to provide fair access to the bus by the two or more devices. A main bus may, for example, interconnect one or more processors such as the hardware processor 602 with a main memory such as the main memory 604 and with a hub or controller (not shown). The hub or controller may interconnect the main bus with other devices shown such as a graphics display device 610, sensors 628, a power management device 632, and/or the like.

The machine 600 may further include the power management device 632, the graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a retransmission logic circuitry 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The operations in accordance with one or more example embodiments of the present disclosure may be carried out by a baseband processor such as the baseband processing circuitry 1218 and/or 1248 shown in FIG. 1C. The baseband processor may be configured to generate corresponding baseband signals. The baseband processor may further include physical layer (PHY) and medium access control (MAC) layer circuitry and may further interface with the hardware processor 602 for generation and processing of the baseband signals and for controlling operations of the main memory 604, the storage device 616, and/or the retransmission logic circuitry 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, within the baseband processor, or within the hardware processor 602 during execution thereof by the machine 600. In an example, one or any combination of the hardware processor 602, the baseband processor, the main memory 604, the static memory 606, or the storage device 616 may constitute machine-readable media.

The retransmission logic circuitry 619 may reside in the machine-readable media and may carry out or perform any of the operations and processes in relation to retransmission schemes or the like (e.g., flowchart 4000 shown in FIG. 4A and flowchart 4100 shown in FIG. 4B) described and shown herein. It is understood that the above are only a subset of what the retransmission logic circuitry 619 may be configured to perform and that other functions included throughout this disclosure may also be performed by the retransmission logic circuitry 619.

While the machine-readable medium 622 is illustrated as a single medium, the term “machine-readable medium” may include a single medium or multiple media (e.g., a centralized or distributed database, a centralized or distributed memory, and/or associated caches, registers, buffers, and servers) configured to store the one or more instructions 624.

Various embodiments may be implemented fully or partially in software and/or firmware. This software and/or firmware may take the form of instructions or code contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the functions discussed in the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

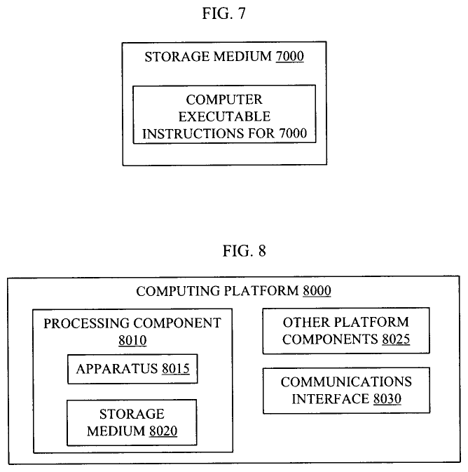

FIG. 7 illustrates an example of a storage medium 7000 to store code and data as retransmission logic circuitry such as logic to implement the retransmission logic circuitry 619 shown in FIG. 6 and/or the other logic discussed herein for retransmission schemes. Storage medium 7000 may comprise an article of manufacture. In some examples, storage medium 7000 may include any non-transitory computer readable medium or machine-readable medium, such as an optical, magnetic or semiconductor storage. Storage medium 7000 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 8 illustrates an example computing platform 8000 such as the STAs illustrated in FIGS. 1A-G. In some examples, as shown in FIG. 8, computing platform 8000 may include a processing component 8010, other platform components or a communications interface 8030 such as the wireless network interfaces 1222 and 1252 shown in FIG. 1C. According to some examples, computing platform 8000 may be a computing device such as a server in a system such as a data center or server farm that supports a manager or controller for managing configurable computing resources as mentioned above. In some embodiments, the computing platform may comprise a mobile device such as a smart phone, a tablet, a notebook, a laptop, a headset, a power amplifier, a television, a speaker, a video/audio streaming device, a stereo, and/or the like.

According to some examples, processing component 8010 may execute processing operations or logic for apparatus 8015 described herein. Processing component 8010 may include various hardware elements, software elements, or a combination of both. Examples of hardware elements may include devices, logic devices, components, processors, microprocessors, circuits, circuitry, processor circuits, processing circuitry, circuit elements (e.g., transistors, resistors, capacitors, inductors, and so forth), integrated circuits (ICs), application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 8020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. While discussions herein describe elements of embodiments as software elements and/or hardware elements, decisions to implement an embodiment using hardware elements and/or software elements may vary in accordance with any number of design considerations or factors, such as desired computational rate, power levels, heat tolerances, processing cycle budget, input data rates, output data rates, memory resources, data bus speeds and other design or performance constraints.

In some examples, other platform components 8025 may include common computing elements, such as one or more processors, multi-core processors, co-processors, memory units, chipsets, controllers, peripherals, interfaces, oscillators, timing devices, video cards, audio cards, accelerator cards, neural network accelerator cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., universal serial bus (USB) memory), solid state drives (SSD) and any other type of storage media suitable for storing information.

In some examples, communications interface 8030 may include logic and/or features to support a communication interface. For these examples, communications interface 8030 may include one or more communication interfaces that operate according to various communication protocols or standards to communicate over direct or network communication links. Direct communications may occur via use of communication protocols or standards described in one or more industry standards (including progenies and variants) such as those associated with the Peripheral Component Interconnect (PCI) Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 8000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, various embodiments of the computing platform 8000 may include or exclude functions and/or specific configurations of the computing platform 8000 described herein.

The components and features of computing platform 8000 may comprise any combination of discrete circuitry, ASICs, logic gates and/or single chip architectures. Further, the features of computing platform 8000 may comprise microcontrollers, programmable logic arrays and/or microprocessors or any combination of the foregoing where suitably appropriate. Note that hardware, firmware and/or software elements may be collectively or individually referred to herein as “logic”. “Logic circuitry” may comprise one or more or any combination of hardware elements, software elements, code, data, processing components 8010, other platform components 8025, communications interface 8030, and/or the like, configured to perform any of the functionality discussed with respect to FIGS. 1-8.

One or more aspects of at least one example may comprise representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

### Advantages of Some Embodiments

Several embodiments have one or more potentially advantages effects. For instance, retransmission logic circuitry, advantageously may efficiently find all potentially optimal network coding retransmission schemes for any application scenario when reliability is required within a time limit. The discovered schemes improve spectral efficiency and reduces latency of the wireless transmission, which helps enable high reliability applications in Wi-Fi (and other similar) systems and enhances user experiences. Several embodiments may advantageously determine a first set of packets for transmission to a second STA in an aggregated medium access control (MAC) protocol data unit (A-MPDU); identify a retransmission scheme generated based on a time constraint, the retransmission scheme to determine a first number of packets to transmit based on the first set of packets; generate one or more network coded packets of a pool of network coded packets for transmission in the A-MPDU, wherein the one or more network coded packets comprise encoded combinations of the first set of packets; generate the A-MPDU for transmission to the second STA with the first number of packets, the first number of packets comprising at least one of the one or more network coded packets from the pool of network coded packets; and cause transmission of the A-MPDU to the second STA. Several embodiments may advantageously encode linear combinations of packets with linearly independent encodings. Many embodiments may advantageously encode linear combinations of packets with linear packet-level coding having a maximum distance separable (MDS) property. Many embodiments may advantageously receive a block acknowledgement (BlockAck) comprising a feedback value, wherein the feedback value is a number of additional network coded packets requested by the second STA to decode the first set of packets or a number of packets received by the second STA. In many embodiments, the feedback value may advantageously provide no indication of which packets have been received by the second STA and no indication of which packets are being requested by the second STA. Many embodiments may advantageously repeatedly cause transmission, in accordance with a corresponding sub-scheme of the retransmission scheme, wherein a number of network coded packets in the pool of network coded packets selected for transmission for each of the sub-schemes is a function of a corresponding feedback value received from the second STA and a time remaining for the retransmission scheme; and repeatedly receive BlockAcks from the second STA, if sufficient time remains to receive the BlockAcks, wherein each of the BlockAcks comprises the corresponding feedback value, wherein the corresponding feedback value is a number of additional network coded packets requested by the second STA to decode the first set of packets or a number of packets received by the second STA. Many embodiments may advantageously receive a first number of packets from a first STA in an aggregated medium access control (MAC) protocol data unit (A-MPDU), the first number of packets comprising network coded packets for a retransmission scheme; decode the first number of packets in accordance with a network coding scheme associated with the retransmission scheme, to determine one or more packets of a first set of packets; determine a feedback value, wherein the feedback value is a number of additional network coded packets to decode the first set of packets or a number of packets received by the second STA; generate the block acknowledgement (BlockAck) comprising the feedback value; and cause transmission of the BlockAck to the first STA. And many embodiments may advantageously receive a second A-MPDU comprising a second number of packets; decode the second number of network coded packets with one or more of the first number of packets to determine additional packets of the first set of packets; and if sufficient time remains to transmit a second BlockAck compute a second feedback value based on the total number of the first set of packets decoded or the number of packets received; generate the second BlockAck comprising the second feedback value; and cause transmission of the second BlockAck.

### Examples of Further Embodiments

The following examples pertain to further embodiments. Specifics in the examples may be used anywhere in one or more embodiments.

Example 1 is an apparatus comprising a memory; and logic circuitry of a first station (STA) coupled with the memory to determine a first set of packets for transmission to a second STA in an aggregated medium access control (MAC) protocol data unit (A-MPDU); identify a retransmission scheme generated based on a time constraint, the retransmission scheme to determine a first number of packets to transmit based on the first set of packets; generate one or more network coded packets of a pool of network coded packets for transmission in the A-MPDU, wherein the one or more network coded packets comprise encoded combinations of the first set of packets; generate the A-MPDU for transmission to the second STA with the first number of packets, the first number of packets comprising at least one of the one or more network coded packets from the pool of network coded packets; and cause transmission of the A-MPDU to the second STA. In Example 2, the apparatus of Example 1, wherein the logic circuitry comprises a processor coupled with the memory, and further comprising a radio coupled with the processor, a front-end module coupled with the radio, and an antenna coupled with the front-end module to transmit the A-MPDU. In Example 3, the apparatus of Example 1, wherein the one or more network coded packets are linearly independent for any subset of network coded packets equal to or less than the number of packets in the first set of packets. In Example 4, the apparatus of Example 1, wherein the one or more network coded packets comprise linear combinations of the first set of packets encoded with linear packet-level coding having a maximum distance separable (MDS) property. In Example 5, the apparatus of Example 1, wherein the first number of network code packets comprises the first set of packets in addition to the one or more network coded packets. In Example 6, the apparatus of Example 1, the logic circuitry to further receive a block acknowledgement (BlockAck) comprising a feedback value, wherein the feedback value is a number of additional network coded packets requested by the second STA to decode the first set of packets or a number of packets received by the second STA. In Example 7, the apparatus of Example 6, wherein the feedback value provides no indication of which packets have been received by the second STA and no indication of which packets are being requested by the second STA. In Example 8, the apparatus of Example 6, the logic circuitry to further determine a second number of packets based on a first sub-scheme of the retransmission scheme and based on the feedback value; cause transmission of the second number of packets in a second A-MPDU; and receive a second BlockAck comprising a second feedback value if sufficient time remains to receive the second BlockAck. In Example 9, the apparatus of Example 1, the logic circuitry to further repeatedly cause transmission, in accordance with a corresponding sub-scheme of the retransmission scheme, wherein a number of network coded packets in the pool of network coded packets selected for transmission for each of the sub-schemes is a function of a corresponding feedback value received from the second STA and a time remaining for the retransmission scheme; and repeatedly receive BlockAcks from the second STA, if sufficient time remains to receive the BlockAcks, wherein each of the BlockAcks comprises the corresponding feedback value, wherein the corresponding feedback value is a number of additional network coded packets requested by the second STA to decode the first set of packets or a number of packets received by the second STA. In Example 10, the apparatus of Example 1, the logic circuitry to further select a process by which to compute the retransmission scheme, the process comprising a discrete process or a continuous process, the logic circuitry to select the discrete process if a transmission time for one of the one or more network coded packets and a sum (d) of a feedback time and a gap time are multiples of a common unit time. In Example 11, the apparatus of Example 1, the logic circuitry to further determine a set of potentially optimal schemes based on the time constraint, a packet loss rate, a feedback time, and a gap time; and identify the retransmission scheme from the set of potentially optimal schemes. In Example 12, the apparatus of Example 1, the logic circuitry to generate the one or more network coded packets of the pool of network coded packets as needed in response to each feedback value received from the second STA, wherein the one or more network coded packets network are generated with systematic network codes known by the first STA and the second STA.

Example 13 is a non-transitory computer-readable medium, comprising instructions, which when executed by a processor, cause the processor to perform operations to determine, for a first station (STA), a first set of packets for transmission to a second STA in an aggregated medium access control (MAC) protocol data unit (A-MPDU); identify a retransmission scheme generated based on a time constraint, the retransmission scheme to determine a first number of packets to transmit based on the first set of packets; generate one or more network coded packets of a pool of network coded packets for transmission in the A-MPDU, wherein the one or more network coded packets comprise encoded combinations of the first set of packets; generate the A-MPDU for transmission to the second STA with the first number of packets, the first number of packets comprising at least one of the one or more network coded packets from the pool of network coded packets; and cause transmission of the A-MPDU to the second STA. In Example 14, the non-transitory computer-readable medium of Example 13, wherein the one or more network coded packets are linearly independent for any subset of network coded packets equal to or less than the number of packets in the first set of packets. In Example 15, the non-transitory computer-readable medium of Example 13, wherein the one or more network coded packets comprise linear combinations of the first set of packets encoded with linear packet-level coding having a maximum distance separable (MDS) property. In Example 16, the non-transitory computer-readable medium of Example 13, wherein the first number of network code packets comprises the first set of packets in addition to the one or more network coded packets. In Example 17, the non-transitory computer-readable medium of Example 13, the operations to further receive a block acknowledgement (BlockAck) comprising a feedback value, wherein the feedback value is a number of additional network coded packets requested by the second STA to decode the first set of packets or a number of packets received by the second STA. In Example 18, the non-transitory computer-readable medium of Example 17, wherein the feedback value provides no indication of which packets have been received by the second STA and no indication of which packets are being requested by the second STA. In Example 19, the non-transitory computer-readable medium of Example 17, the operations to further determine a second number of packets based on a first sub-scheme of the retransmission scheme and based on the feedback value; cause transmission of the second number of packets in a second A-MPDU; and receive a second BlockAck comprising a second feedback value if sufficient time remains to receive the second BlockAck. In Example 20, the non-transitory computer-readable medium of Example 13, the operations to further repeatedly cause transmission, in accordance with a corresponding sub-scheme of the retransmission scheme, wherein a number of network coded packets in the pool of network coded packets selected for transmission for each of the sub-schemes is a function of a corresponding feedback value received from the second STA and a time remaining for the retransmission scheme; and repeatedly receive BlockAcks from the second STA, if sufficient time remains to receive the BlockAcks, wherein each of the BlockAcks comprises the corresponding feedback value, wherein the corresponding feedback value is a number of additional network coded packets requested by the second STA to decode the first set of packets or a number of packets received by the second STA. In Example 21, the non-transitory computer-readable medium of Example 13, the operations to further select a process by which to compute the retransmission scheme, the process comprising a discrete process or a continuous process, the operations to select the discrete process if a transmission time for one of the one or more network coded packets and a sum of a feedback time and a gap time are multiples of a common unit time. In Example 22, the non-transitory computer-readable medium of Example 13, the operations to further determine a set of potentially optimal schemes based on the time constraint, a packet loss rate, a feedback time, and a gap time; and identify the retransmission scheme from the set of potentially optimal schemes. In Example 23, the non-transitory computer-readable medium of Example 13, the operations to generate the one or more network coded packets of the pool of network coded packets as needed in response to each feedback value received from the second STA, wherein the one or more network coded packets network are generated with systematic network codes known by the first STA and the second STA.

Example 24 is an apparatus comprising a memory; and logic circuitry of a second station (STA) coupled with the memory to receive a first number of packets from a first STA in an aggregated medium access control (MAC) protocol data unit (A-MPDU), the first number of packets comprising network coded packets for a retransmission scheme; decode the first number of packets in accordance with a network coding scheme associated with the retransmission scheme, to determine one or more packets of a first set of packets; determine a feedback value, wherein the feedback value is a number of additional network coded packets to decode the first set of packets or a number of packets received by the second STA; generate the block acknowledgement (BlockAck) comprising the feedback value; and cause transmission of the BlockAck to the first STA. In Example 25, the apparatus of Example 24, wherein the logic circuitry comprises a processor coupled with the memory, and further comprising a radio coupled with the processor, a front-end module coupled with the radio, and an antenna coupled with the front-end module to transmit the BlockAck. In Example 26, the apparatus of Example 24, wherein the network coded packets are linearly independent for any subset of network coded packets equal to or less than the number of packets in the first set of packets. In Example 27, the apparatus of Example 24, wherein the network coded packets comprise linear combinations of the first set of packets encoded with linear packet-level coding having a maximum distance separable (MDS) property. In Example 28, the apparatus of Example 24, wherein the first number of network code packets comprises the first set of packets in addition to the network coded packets. In Example 29, the apparatus of Example 24, the logic circuitry to further receive a second A-MPDU comprising a second number of packets; decode the second number of network coded packets with one or more of the first number of packets to determine additional packets of the first set of packets; and if sufficient time remains to transmit a second BlockAck compute a second feedback value based on the total number of the first set of packets decoded or the number of packets received; generate the second BlockAck comprising the second feedback value; and cause transmission of the second BlockAck. In Example 30, the apparatus of Example 29, wherein the feedback value provides no indication of which packets have been received by the second STA and no indication of which packets are being requested by the second STA.

Example 31 is a non-transitory computer-readable medium, comprising instructions, which when executed by a processor, cause the processor to perform operations to receive a first number of packets from a first station (STA) in an aggregated medium access control (MAC) protocol data unit (A-MPDU), the first number of packets comprising network coded packets for a retransmission scheme; decode the first number of packets in accordance with a network coding scheme associated with the retransmission scheme, to determine one or more packets of a first set of packets; determine a feedback value for a second STA, wherein the feedback value is a number of additional network coded packets to decode the first set of packets or a number of packets received by the second STA; generate the block acknowledgement (BlockAck) comprising the feedback value; and cause transmission of the BlockAck to the first STA. In Example 32, the non-transitory computer-readable medium of Example 31, wherein the network coded packets are linearly independent for any subset of network coded packets equal to or less than the number of packets in the first set of packets. In Example 33, the non-transitory computer-readable medium of Example 31, wherein the network coded packets comprise linear combinations of the first set of packets encoded with linear packet-level coding having a maximum distance separable (MDS) property. In Example 34, the non-transitory computer-readable medium of Example 31, wherein the first number of network code packets comprises the first set of packets in addition to the network coded packets. In Example 35, the non-transitory computer-readable medium of Example 31, the operations to further receive a second A-MPDU comprising a second number of network coded packets; decode the second number of network coded packets with one or more of the first number of packets to determine additional packets of the first set of packets; and if sufficient time remains to transmit a second BlockAck compute a second feedback value based on the total number of the first set of packets decoded or the number of packets received; generate the second BlockAck comprising the second feedback value; and cause transmission of the second BlockAck. In Example 36, the non-transitory computer-readable medium of Example 35, wherein the feedback value provides no indication of which packets have been received by the second STA and no indication of which packets are being requested by the second STA.

Example 37 is a method to perform any one or more of Examples 13 though 23.

Example 38 is an apparatus comprising a means for performing any one or more of Examples 13 though 23.

Example 39 is a method to perform any one or more of Examples 31 though 36.

Example 40 is an apparatus comprising a means for performing any one or more of Examples 31 though 36.

What is claimed is:

1. An apparatus comprising:
a memory; and
logic circuitry of a first station (STA) coupled with the memory to:
determine a first set of packets for transmission to a second STA in an aggregated medium access control (MAC) protocol data unit (A-MPDU);
identify a retransmission scheme generated based on a time constraint, the retransmission scheme to determine a first number of packets to transmit based on the first set of packets;
generate one or more network coded packets of a pool of network coded packets for transmission in the A-MPDU, wherein the one or more network coded packets comprise encoded combinations of the first set of packets;
generate the A-MPDU for transmission to the second STA with the first number of packets, the first number of packets comprising at least one of the one or more network coded packets from the pool of network coded packets; and
cause transmission of the A-MPDU to the second STA.

2. The apparatus of claim 1, wherein the logic circuitry comprises a processor coupled with the memory, and further comprising a radio coupled with the processor, a front-end module coupled with the radio, and an antenna coupled with the front-end module to transmit the A-MPDU.

3. The apparatus of claim 1, wherein the one or more network coded packets are linearly independent for any subset of network coded packets equal to or less than the number of packets in the first set of packets.

4. The apparatus of claim 1, the logic circuitry to further receive a block acknowledgement (BlockAck) comprising a feedback value, wherein the feedback value is a number of additional network coded packets requested by the second STA to decode the first set of packets or a number of packets received by the second STA, wherein the feedback value provides no indication of which packets have been received by the second STA and no indication of which packets are being requested by the second STA.

5. The apparatus of claim 4, the logic circuitry to further:
determine a second number of packets based on a first sub-scheme of the retransmission scheme and based on the feedback value;
cause transmission of the second number of packets in a second A-MPDU; and
receive a second BlockAck comprising a second feedback value if sufficient time remains to receive the second BlockAck.

6. The apparatus of claim 1, the logic circuitry to further:
repeatedly cause transmission, in accordance with a corresponding sub-scheme of the retransmission scheme, wherein a number of network coded packets in the pool of network coded packets selected for transmission for each of the sub-schemes is a function of a corresponding feedback value received from the second STA and a time remaining for the retransmission scheme; and
repeatedly receive BlockAcks from the second STA, if sufficient time remains to receive the BlockAcks, wherein each of the BlockAcks comprises the corresponding feedback value, wherein the corresponding feedback value is a number of additional network coded packets requested by the second STA to decode the first set of packets or a number of packets received by the second STA.

7. The apparatus of claim 1, the logic circuitry to further select a process by which to compute the retransmission scheme, the process comprising a discrete process or a continuous process, the logic circuitry to select the discrete process if a transmission time for one of the one or more network coded packets and a sum of a feedback time and a gap time are multiples of a common unit time.

8. The apparatus of claim 1, the logic circuitry to further:
determine a set of potentially optimal schemes based on the time constraint, a packet loss rate, a feedback time, and a gap time; and
identify the retransmission scheme from the set of potentially optimal schemes.

9. A non-transitory computer-readable medium, comprising instructions, which when executed by a processor, cause the processor to perform operations to:
determine, for a first station (STA), a first set of packets for transmission to a second STA in an aggregated medium access control (MAC) protocol data unit (A-MPDU);
identify a retransmission scheme generated based on a time constraint, the retransmission scheme to determine a first number of packets to transmit based on the first set of packets;
generate one or more network coded packets of a pool of network coded packets for transmission in the A-MPDU, wherein the one or more network coded packets comprise encoded combinations of the first set of packets;
generate the A-MPDU for transmission to the second STA with the first number of packets, the first number of packets comprising at least one of the one or more network coded packets from the pool of network coded packets; and
cause transmission of the A-MPDU to the second STA.

10. The non-transitory computer-readable medium of claim 9, wherein the one or more network coded packets comprise linear combinations of the first set of packets encoded with linear packet-level coding having a maximum distance separable (MDS) property.

11. The non-transitory computer-readable medium of claim 9, the operations to further receive a block acknowledgement (BlockAck) comprising a feedback value, wherein the feedback value is a number of additional network coded packets requested by the second STA to decode the first set of packets or a number of packets received by the second STA.

12. The non-transitory computer-readable medium of claim 11, the operations to further:
determine a second number of packets based on a first sub-scheme of the retransmission scheme and based on the feedback value;
cause transmission of the second number of packets in a second A-MPDU; and
receive a second BlockAck comprising a second feedback value if sufficient time remains to receive the second BlockAck.

13. An apparatus comprising:
a memory; and
logic circuitry of a second station (STA) coupled with the memory to:
receive a first number of packets from a first STA in an aggregated medium access control (MAC) protocol data unit (A-MPDU), the first number of packets comprising network coded packets for a retransmission scheme;
decoding the first number of packets in accordance with a network coding scheme associated with the retransmission scheme, to determine one or more packets of a first set of packets;
determine a feedback value, wherein the feedback value is a number of additional network coded packets to decode the first set of packets or a number of packets received by the second STA;
generate the block acknowledgement (BlockAck) comprising the feedback value; and
cause transmission of the BlockAck to the first STA.

14. The apparatus of claim 13, wherein the logic circuitry comprises a processor coupled with the memory, and further comprising a radio coupled with the processor, a front-end module coupled with the radio, and an antenna coupled with the front-end module to transmit the BlockAck.

15. The apparatus of claim 13, wherein the network coded packets are linearly independent for any subset of network coded packets equal to or less than the number of packets in the first set of packets.

16. The apparatus of claim 13, the logic circuitry to further:
receive a second A-MPDU comprising a second number of packets;
decode the second number of network coded packets with one or more of the first number of packets to determine additional packets of the first set of packets; and
if sufficient time remains to transmit a second BlockAck:
compute a second feedback value based on the total number of the first set of packets decoded or the number of packets received;
generate the second BlockAck comprising the second feedback value; and
cause transmission of the second BlockAck.

17. A non-transitory computer-readable medium, comprising instructions, which when executed by a processor, cause the processor to perform operations to:
receive a first number of packets from a first station (STA) in an aggregated medium access control (MAC) protocol data unit (A-MPDU), the first number of packets comprising network coded packets for a retransmission scheme;
decode the first number of packets in accordance with a network coding scheme associated with the retransmission scheme, to determine one or more packets of a first set of packets;
determine a feedback value for a second STA, wherein the feedback value is a number of additional network coded packets to decode the first set of packets or a number of packets received by the second STA;
generate the block acknowledgement (BlockAck) comprising the feedback value; and
cause transmission of the BlockAck to the first STA.

18. The non-transitory computer-readable medium of claim 17, wherein the network coded packets comprise linear combinations of the first set of packets encoded with linear packet-level coding having a maximum distance separable (MDS) property.

19. The non-transitory computer-readable medium of claim 17, the operations to further:
receive a second A-MPDU comprising a second number of network coded packets;
decode the second number of network coded packets with one or more of the first number of packets to determine additional packets of the first set of packets; and
if sufficient time remains to transmit a second BlockAck:
compute a second feedback value based on the total number of the first set of packets decoded or the number of packets received;
generate the second BlockAck comprising the second feedback value; and
cause transmission of the second BlockAck.

20. The non-transitory computer-readable medium of claim 19, wherein the feedback value provides no indication of which packets have been received by the second STA and no indication of which packets are being requested by the second STA.
